(19) United States
(12) Patent Application Publication
(10) Pub. No.: US 2025/0292688 A1
(43) Pub. Date: Sep. 18, 2025

(54) ELECTRONIC DEVICE AND METHOD FOR CHANGING FORMATION OF PLATOONING VEHICLES

(71) Applicant: THINKWARE CORPORATION, Seongnam-si (KR)

(72) Inventor: Dongwon SHIN, Seongnam-si (KR)

(21) Appl. No.: 19/077,367

(22) Filed: Mar. 12, 2025

(30) Foreign Application Priority Data
Mar. 12, 2024 (KR) 10-2024-0034648

(51) Int. Cl. G08G 1/00; G01C 21/00; G06V 10/82; G06V 20/58

(52) U.S. Cl. CPC G08G 1/22; G01C 21/3848; G06V 10/82; G06V 20/58

(57) ABSTRACT

An electronic device for platooning of vehicles may identify first information related to a first formation, obtain second information related to whether at least a portion of a second lane, which is distinct from the first lane, is unoccupied, determine a second formation based on the second information, distinguish the vehicles into a first group of vehicles including a leading vehicle and a second group of vehicles including only following vehicles, based on the second formation, and transmit a signal to the following vehicles included in the second group of vehicles to move the second group of vehicles to the second lane.

### CROSS-REFERENCE TO RELATED APPLICATIONS

This application is based on and claims priority under 35 U.S.C. § 119 to Korean Patent Application No. 10-2024-0034648, filed on Mar. 12, 2024, in the Korean Intellectual Property Office, the disclosure of which is incorporated by reference herein in its entirety.

### BACKGROUND

### Field

The disclosure relates to an electronic device and a method for changing the formation of platooning vehicles.

### Description of Related Art

Platooning is a technology that controls the autonomous driving of two or more vehicles. Platooning vehicles may drive in a certain formation. Platooning may enhance fuel efficiency by reducing inter-vehicle gaps and hence air resistance, reducing the risk of accidents, and reducing traffic congestion by controlling the flow of vehicles. Platooning vehicles may include a leading vehicle and following vehicles. An electronic device equipped to the leading vehicle may control platooning. For example, the electronic device may identify the surrounding environment, set a driving route based on the surrounding environment, and control the speed and direction of vehicles. For example, the electronic device may determine the formation of the platoon.

### SUMMARY

A platoon may be separated according to the formation of the platoon. It may be required to appropriately change the formation of the platoon according to contexts.

An electronic for platooning of vehicles is provided. An electronic device according to an embodiment may comprise a processor and a memory storing instructions. The instructions may, when executed by the processor, cause the electronic device to identify first information related to a first formation of the vehicles, obtain second information related to whether at least a portion of a second lane, which is distinct from the first lane where the vehicles are located, is unoccupied while controlling the vehicles in the first formation, determine a second formation to move some of the vehicles to the second lane, based on the second information, distinguish the vehicles into a first group of vehicles including a leading vehicle and a second group of vehicles including only following vehicles, based on the second formation, and transmit a signal to the following vehicles included in the second group of vehicles to move the second group of vehicles to the second lane.

A method performed by an electronic device is provided. A method of an electronic device according to an embodiment may comprise identifying first information related to a first formation of platooning vehicles. The method may comprise obtaining second information related to whether at least a portion of a second lane, which is distinct from the first lane where the vehicles are located, is unoccupied while controlling the vehicles in the first formation. The method may comprise determining a second formation to move some of the vehicles to the second lane, based on the second information. The method may comprise distinguishing the vehicles into a first group of vehicles including a leading vehicle and a second group of vehicles including only following vehicles, based on the second formation. The method may comprise transmitting a signal to the following vehicles included in the second group of vehicles to move the second group of vehicles to the second lane.

While vehicles are controlled in a platooning mode, the electronic device may appropriately change the formation of the platoon according to the context of the road. As the formation of the platoon is changed, the separation of the platoon may be reduced.

### BRIEF DESCRIPTION OF THE DRAWINGS

FIG. 1 schematically illustrates platooning vehicles.

FIG. 2 is a block diagram illustrating electronic devices for platooning vehicles according to an embodiment.

FIG. 3 is a flowchart illustrating operations of an electronic device for changing the formation of a platoon.

FIG. 4 schematically illustrates a process of changing the formation of a platoon by the operations of FIG. 3.

FIG. 5 is a flowchart illustrating operations of an electronic device for changing the formation of a platoon when another vehicle is present.

FIG. 6 schematically illustrates a process of changing the formation of a platoon by the operations of FIG. 5.

FIG. 7 is a flowchart illustrating operations of an electronic device for changing the formation of a platoon when a second lane includes a plurality of lanes.

FIG. 8 schematically illustrates a process of changing the formation of a platoon by the operations of FIG. 7.

FIG. 9 schematically illustrates a process of changing the formation of a platoon.

FIGS. 10A, 10B, and 10C illustrate an example of a process of generating a local map based on environment information received from vehicles by an electronic device according to an embodiment.

FIG. 11 illustrates another example of a process of generating a local map based on environment information received from vehicles by an electronic device according to an embodiment.

FIG. 12 is an example block diagram illustrating an autonomous driving system of a vehicle according to an embodiment.

FIGS. 13 and 14 are example block diagrams illustrating an autonomous driving mobile body according to an embodiment.

FIG. 15 illustrates an example of a gateway related to a user device according to various embodiments.

FIG. 16 is a view illustrating operations of an electronic device training a neural network based on a set of training data according to an embodiment.

FIG. 17 is a block diagram illustrating an electronic device according to an embodiment.

FIGS. 18A and 18B illustrate an example of a vehicle performing platooning.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 100). For example, a processor (e.g., the processor 110) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, embodiments of the disclosure are described with reference to the accompanying drawings.

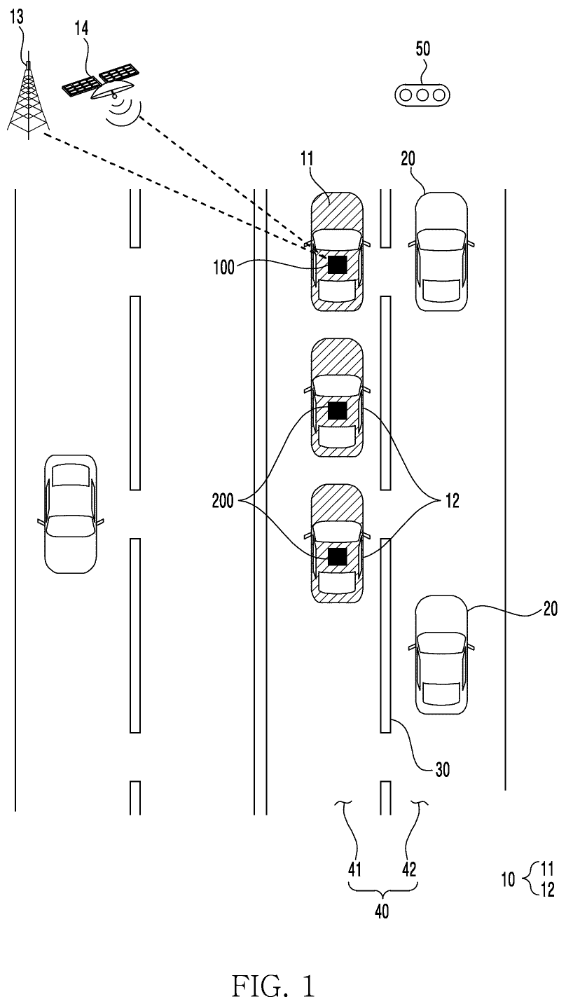

FIG. 1 schematically illustrates platooning vehicles.

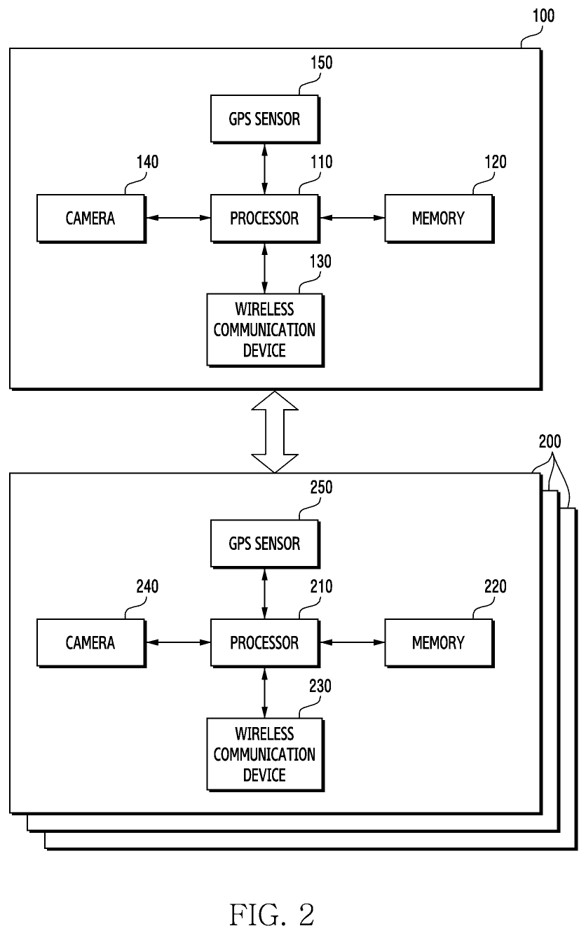

Platooning is a technology of controlling two or more vehicles 10 forming a platoon to drive while maintaining a designated formation. Each of the vehicles 10 may include electronic devices (e.g., the electronic device 100 of FIG. 2 and other electronic devices 200) for platooning. The electronic devices 100 and 200 may share control information about the vehicles 10 and information collected through the electronic devices 100 and 200 respectively disposed in the vehicles 10 in real-time using vehicle-to-everything (V2X) communication technology. The wireless access technologies for exchanging information between the electronic devices 100 and 200 shown in FIG. 1 may use various wireless access technologies, such as vehicle-to-infrastructure (V2I), vehicle-to-device (V2D), vehicle-to-vehicle (V2V), vehicle-to-pedestrian (V2P) or such vehicle-to-everything (V2X), cellular 5G new radio (NR) sidelink, 802-11-based dedicated short range communication (DSRC), or the like.

The vehicles 10 may be divided into a leading vehicle 11 and following vehicles 12. The leading vehicle 11 may be referred to as a vehicle positioned at the front among the platooning vehicles 10, and the following vehicles 12 may be referred to as the remaining vehicles except for the leading vehicle 11. The electronic device 100 disposed in the leading vehicle 11 may be used to control the overall operation of the platooning. For example, since the leading vehicle 11 is positioned at the front in the platoon, the electronic device 100 may obtain more diverse information than the other electronic devices 200.

The electronic device 100 may transmit and/or receive data to and/or from an external electronic device (e.g., the base station 13 and/or the satellite 14). For example, the electronic device 100 may receive data including information related to the driving route from an external electronic device 13 or 14 to determine the driving route and transmit data including information related to the real-time position of the platoon to the external electronic device 13 or 14.

The electronic device 100 may be configured to control driving of the vehicles 10 based on information (e.g., driving route, driving speed, interval between the vehicles 10, and/or formation of the platoon) related to the platooning vehicles 10 and/or information (e.g., road condition, another vehicle 20, line 30, and/or lane 40) related to the surrounding environment. For example, the electronic device 100 may transmit a signal for controlling platooning to each of the other electronic devices 200 respectively disposed in the following vehicles 12. The other electronic devices 200 may be configured to control driving of following vehicles 12 based on the signal received from the electronic device 100.

While the vehicles 10 are controlled in a platooning mode, the platoon may be separated. For example, when another vehicle 20 cuts in between the vehicles 10, or when the vehicles 10 pass through a traffic light 50, the platoon may be separated as not all of the vehicles 10 in the platoon pass through the signal of the traffic light 50. When the vehicles 10 are separated into a plurality of groups, the gap between the plurality of groups may be increased by the traffic light 50 positioned on the driving route. For example, when the platoon is separated into a leading group and a following group, a gap between the leading group and the following group may widen when the leading group passes without stopping by the traffic light 50 and the following group passes after waiting by the traffic light 50. When the platoon is separated, it is difficult to control the vehicles 10 by platooning. Therefore, in order to put the separated groups back together, issues such as a change of the driving route (rescheduling), re-routing of the driving route, or an occasion in which the leading group waits at a specific point and then merges back into one platoon may occur.

The electronic device 100 for platooning according to an embodiment may identify a circumstance of another lane (e.g., the second lane 42) distinct from the driving lane (e.g., the first lane 41) of the vehicles 10 while the vehicles 10 are controlled in the platooning mode, and may change the formation of the platoon when at least a portion of the other lane is empty. For example, while waiting for a signal of the traffic light 50, the formation of the platoon may be changed. Changing the formation of the platoon may reduce separation of the platoon. For example, it is possible to reduce separation of the platoon by moving some of the vehicles 10 to another empty lane while the vehicles 10 wait for a signal to change the formation and enabling rapid entry/exit when the signal is changed.

Hereinafter, an electronic device 100 for platooning capable of changing the formation of a platoon is described with reference to the drawings. In the disclosure, terms such as first lane and second lane are used merely to distinguish lanes. For example, the first lane is used to describe the lane where the vehicles 10 that maintain the first formation before the change are located, and for example, it does not represent lanes that are close to the center line defined by law or where lane change is not allowed.

FIG. 2 is a block diagram illustrating electronic devices for platooning vehicles according to an embodiment.

Referring to FIG. 2, an electronic device 100 according to an embodiment may include a processor 110, a memory 120, a wireless communication device 130, a camera 140, and/or a global positioning system (GPS) sensor 150. The electronic device 100 according to an embodiment may be referred to as an electronic device disposed in a leading vehicle (e.g., the leading vehicle 11 of FIG. 1).

For example, the processor 110, the memory 120, the wireless communication device 130, a camera 140, and/or a GPS sensor 150 may be electrically and/or operatively connected to each other by an electronic component such as a communication bus. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware.

Although FIG. 2 illustrates that the processor 110, the memory 120, the camera 140, the wireless communication device 130, and/or the GPS sensor 150 in different blocks, the disclosure is not limited thereto. Some of the pieces of hardware of FIG. 2 may be implemented as a single integrated circuit such as a system on chip (SoC) or a single package.

The memory 120 according to an embodiment may store instructions. The processor 110 may be configured to process data based on the instructions stored in the memory 120. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor or a structure of a multi-core processor such as a dual core, a quad core, a hexa core, or an octa core.

According to an embodiment, the memory 120 may include a hardware component for storing data and/or instructions executable by the processor 110. The memory 120 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC). For example, the memory 120 of the electronic device 100 may include a neural network model. The electronic device 100 may identify an external object (e.g., a line (e.g., the line 30 of FIG. 1), a lane (e.g., the lane 40 of FIG. 1), another vehicle (e.g., another vehicle 20 of FIG. 1), and/or a traffic light (e.g., the traffic light 50 of FIG. 1)) based on the neural network model stored in the memory 120.

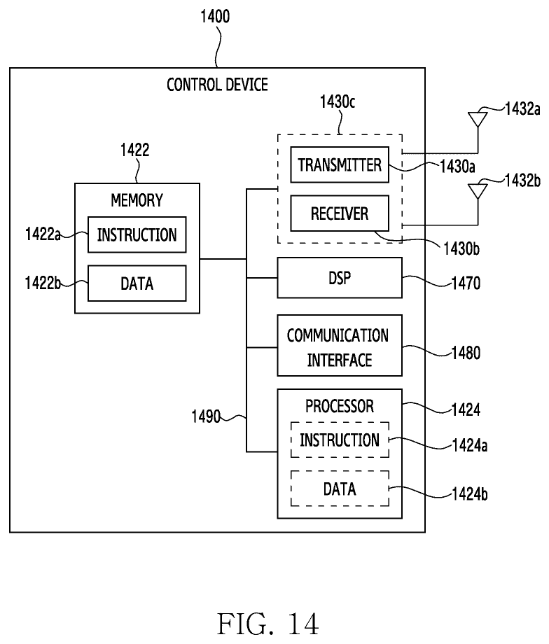

According to an embodiment, the wireless communication device 130 may be used for wireless communication with other electronic devices 200 and/or an external electronic device. For example, the electronic device 100 may be configured to perform wireless communication with an external electronic device (e.g., a base station (e.g., the base station 13 of FIG. 1) and/or a satellite (e.g., the satellite 14 of FIG. 1)) and other electronic devices 200 using the wireless communication device 130. The wireless communication device 130 may be electrically connected to an antenna (e.g., the antenna 1432a or 1432b of FIG. 14) for transmitting and/or receiving a signal. The wireless communication device 130 may convert an analog signal provided from the processor 110 into a digital signal and upconvert a baseband signal into a radio frequency (RF) signal. The electronic device 100 may obtain information related to the real-time position of the platoon using the GPS sensor 150 and transmit data including the information to the external electronic devices 13 and 14 using the wireless communication device 130. The electronic device 100 may transmit signals for controlling driving of the following vehicles (e.g., the following vehicles 12 of FIG. 1) to the wireless communication device 130 of the other electronic devices 200. The other electronic devices 200 may receive the signal through the wireless communication device 230.

According to an embodiment, the camera 140 may include a lens assembly or an image sensor. The lens assembly may collect light emitted or reflected from an object whose image is to be taken. The lens assembly may include one or more lenses. For example, the camera 140 may include a plurality of lens assemblies. For example, some of the plurality of lens assemblies of the camera 140 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 100 may include a flash for the camera 140. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the electronic device 100 may identify the surrounding environments of the leading vehicle 11 using the camera 140. For example, the electronic device 100 may identify an external object based on an image obtained through the camera 140. For example, the electronic device 100 may identify the external object corresponding to the image obtained through the camera 140 using the neural network model. For example, the electronic device 100 may obtain an image corresponding to another vehicle 20 driving on another lane (e.g., the second lane 42 of FIG. 1) through the camera 140, and identify the other vehicle 20 on the other lane 42 from the image.

Other electronic devices 200 disposed in the following vehicles 12 may include substantially the same components as the electronic device 100 disposed in the leading vehicle 11. For example, each of the other electronic devices 200 may include a processor 210, a memory 220, a wireless communication device 230, a camera 240, and/or a GPS sensor 250. The above descriptions of the components of the electronic device 100 may be applied to the components of the other electronic devices 200 in substantially the same manner.

Since the vehicles 10 drive in a designated formation, the camera 240 of another electronic device 100 may obtain an image that the camera 140 of the electronic device 100 may not obtain at a specific timing. According to an embodiment, the other electronic devices 200 may transmit information related to the image obtained through the camera 240 and/or information related to the external object identified from the image to the electronic device 100. The electronic device 100 may identify surrounding environments of the platoon based on the information received from the other electronic devices 200, and control the driving of the platoon based on the surrounding environments.

According to an embodiment, the electronic device 100 may change the formation using a neural network model. For example, the processor 110 may determine whether to change the formation based on information (e.g., first environment information) related to the surrounding environments of the leading vehicle 11 obtained using the camera 140 and the information (e.g., second environment information) received from the following vehicles 12. For example, when at least a portion of another lane (e.g., the second lane 42 of FIG. 1) that is distinct from the lane (e.g., the first lane 41 of FIG. 1) where the platoon is located is empty, the processor 110 may change the formation to move some of the following vehicles 12 to another lane 42. The electronic device 100 may transmit a signal for moving some of the following vehicles 12 to another vehicle 20, and some of the following vehicles 12 may move to another lane 42, at least partially empty, based on the reception of the signal. As some of the following vehicles 12 move to another empty lane, a circumstance in which the formation is changed and the platoon is separated by the change in the formation may be reduced.

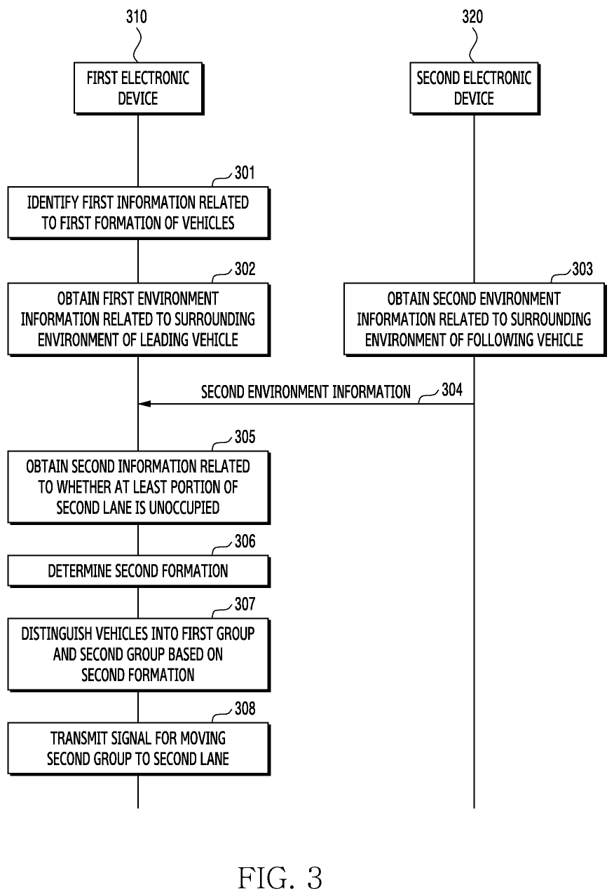

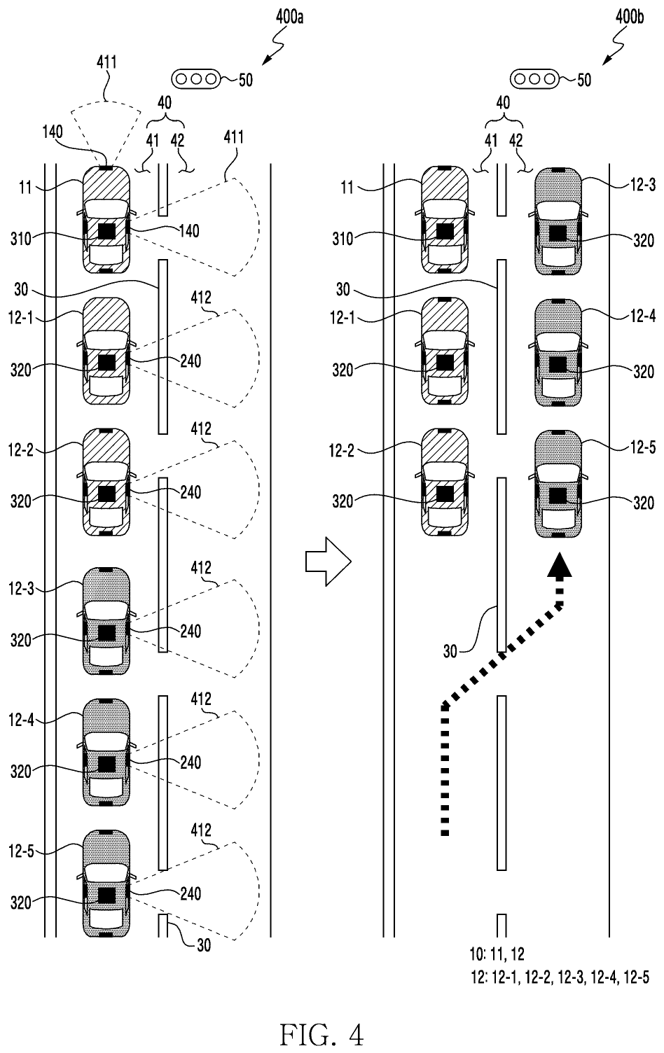

FIG. 3 is a flowchart illustrating operations of an electronic device for changing the formation of a platoon. FIG. 4 schematically illustrates a process of changing the formation of a platoon by the operations of FIG. 3.

The operations described in FIG. 3 may be operations of an electronic device (e.g., the electronic device 100 of FIG. 2) that are caused when instructions stored in the memory (e.g., the memory 120 of FIG. 2) are executed by the processor (e.g., the processor 110 of FIG. 1). In the following description, the electronic device 100 disposed in the leading vehicle (e.g., the leading vehicle 11 of FIG. 1) is referred to as a first electronic device 310, and other electronic devices (e.g., the other electronic devices 200 of FIG. 2) disposed in the following vehicles (e.g., the following vehicles of FIG. 1) are referred to as second electronic devices 320.

Referring to FIG. 3, in operation 301, the first electronic device 310 may identify the first information related to the first formation of vehicles (e.g., the vehicles 10 of FIG. 4) forming a platoon.

For example, when executing instructions stored in the memory 120, the processor 110 may obtain first information related to the first formation of the vehicles 10. The first formation may be referred to as a formation of the platoon before being changed. The formation of the platoon may be defined by a row and a column. The column may be referred to as a line (e.g., a vertical line) of the vehicles 10 arranged in the driving direction of the vehicles 10 forming the platoon. The row may be referred to as a line (e.g., a horizontal line) of the vehicles 10 arranged in a direction perpendicular to the driving direction of the vehicles 10 forming the group.

400a of FIG. 4 illustrates vehicles 10 platooning in the first large, which is a formation before being changed. Referring to 400a of FIG. 4, when the vehicles 10 include a leading vehicle 11 and five following vehicles 12 (e.g., first vehicle 12-1, second vehicle 12-2, third vehicle 12-3, fourth vehicle 12-4, and/or fifth vehicle 12-5), the first formation may be constituted of six rows and one column (e.g., 6×1). The first electronic device 310 may transmit a signal for driving control of the vehicle to each of the second electronic devices 320. The following vehicles 12 may follow the leading vehicle 11 while maintaining a designated interval between the vehicles 10, based on the signal. The first electronic device 310 may identify the first information related to the first formation in real-time while the vehicles 10 are controlled in the platooning mode. For example, in operation 301, the first electronic device 310 may identify first information related to the first formation composed of six rows and one column.

In operation 302, the first electronic device 310 may obtain first environment information related to the surrounding environment of the leading vehicle 11.

For example, when executing instructions stored in the memory 120, the processor 110 may obtain first environment information related to the surrounding environment of leading vehicle 11 based on an image obtained from the camera (e.g., the camera 140 of FIG. 2). The first electronic device 310 may obtain the image using the camera 140. The camera 140 may provide the image obtained by capturing the surrounding environment of the leading vehicle 11 to the processor 110. The processor 110 may obtain the first information related to the surrounding environment of the leading vehicle 11 by identifying an external object in the obtained image. The first electronic device 310 may identify an external object in the obtained image using a neural network. For example, the first electronic device 310 may identify an external object, such as another vehicle 20, line 30, lane 40, and/or traffic light 50, around the leading vehicle 11 using a neural network model pre-trained to identify the external object from the image corresponding to the external object.

In operation 303, the second electronic devices 320 may obtain second environment information related to the surrounding environment of the following vehicles 12. In operation 303, the term “following vehicles” is a relative term used to distinguish from the “leading vehicle” and may refer to vehicles equipped with the second electronic devices 320.

For example, when executing the instructions stored in the memory (e.g., the memory 220 of FIG. 2), the processor (e.g., the processor 210 of FIG. 2) may obtain second environment information related to the surrounding environment of each of the following vehicles 12 based on the image obtained from the camera (e.g., the camera 240 of FIG. 2).

Referring to FIG. 4, since a first angle of view 411 of the camera 140 disposed in the leading vehicle 11 may be limited, there may be a region (e.g., a blind spot) where light emitted from the subject through the lens assembly of the camera 140 may not be collected. For example, since the external object located in the blind spot of the camera 140 may not be captured through the camera 140, at least some of the external objects located around the vehicles 10 may not be included in the first environment information.

According to an embodiment, since the following vehicles 12 drive following the leading vehicle 11, the camera 240 may collect light emitted from the external object located in the blind spot. The camera 240 may provide the processor 210 with an image obtained by capturing the surrounding environment of each of the following vehicles 12. The processor 210 may obtain second environment information related to the surrounding environment of the following vehicles 12 by identifying the external object in the obtained image. As described above, the second electronic devices 320 may also identify the external object in the obtained image using a neural network. Since the first angle of view 411 of the camera 140 and the second angle of view 412 of the camera 240 may partially overlap, the first environment information and the second environment information may include overlapping information.

In operation 304, the first electronic device 310 may receive, from the following vehicles 12, second environment information related to the surrounding environment of the following vehicles 12.

For example, when executing the instructions stored in the memory 120, the processor 110 may receive data including second environment information transmitted from wireless communication device 230 through the wireless communication device 130. The reception of the second environment information may be performed in real-time.

In operation 305, the first electronic device 310 may obtain the second information related to whether at least a portion of the second lane 42 distinct from the first lane 41 where the vehicles 10 are located is empty while controlling the vehicles 10 in a first formation.

For example, when executing the instructions stored in the memory 120, the processor 110 may obtain second information related to whether at least a portion of the second lane 42 is empty based on the first environment information and the second environment information. The first lane 41 may be referred to as a lane where the vehicles 10 platooning in the first formation vehicles are located. The second lane 42 is a lane distinct from the first lane 41, and may be referred to as a lane where the platooning vehicles 10 are not located. For example, as illustrated in FIG. 4, when the first formation is constituted of six rows and one column, and when driving on the left lane, the first lane 41 may be the left lane, and the second lane 42 may be the right lane.

According to an embodiment, the first electronic device 310 may obtain second information related to whether at least a portion of the second lane 42 is empty based on the first environment information and the second environment information. For example, when no other vehicle (e.g., another vehicle 20 of FIG. 1) is located on the second lane 42, as shown in FIG. 4, since there is no image corresponding to the other vehicle 20 in the images obtained through the camera 140 and the camera 240, the first electronic device 310 may obtain second information indicating that the second lane 42 is empty based on the first environment information and the second environment information.

In operation 306, the first electronic device 310 may determine a second formation to move some of the vehicles 10 to the second lane 42 based on the second information.

For example, when executing the instructions stored in the memory 120, the processor 110 may determine the second formation to which to be changed from the first formation to prevent the separation of the platoon based on the second information.

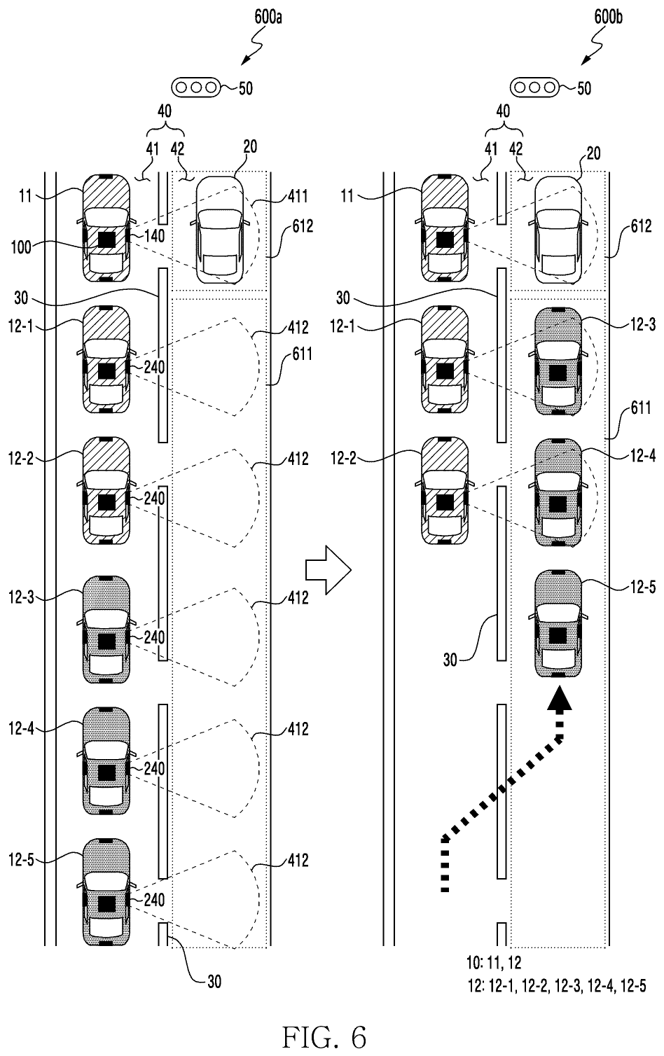

400b of FIG. 4 illustrates vehicles 10 platooning in a second formation, which is a formation after the change. For example, the second formation may include row and column information corresponding to the location of each vehicle in the second formation so that the vehicles platoon according to the second formation. For example, a designated location according to row information and column information may be assigned to each of the vehicles forming the second formation. According to an embodiment, the processor 110 may determine the second formation according to the number of lanes in order to efficiently change the platoon. Referring to 400b of FIG. 4, the second formation may be constituted of three rows and two columns (e.g., 3×2). Since the second lane 42 includes only one lane and the second lane 42 is completely empty, when the vehicles 10 are separated into two columns each having three vehicles, the vehicles 10 may drive while stably maintaining the platoon. For example, when the second lane 42 distinct from the first lane 41 includes only one lane and no other vehicle (e.g., another vehicle 20 of FIG. 6) is present on the second lane 42, the processor 110 may determine the second formation including two columns.

According to an embodiment, the rows (e.g., three rows) of the second formation may be fewer than the rows (e.g., six rows) of the first formation, and the columns (e.g., two columns) of the second formation may be more than the columns (e.g., one column) of the first formation. In this case, since the second formation is shorter than the first formation, separation of the platoon may be prevented. However, the above description applies to the change of the formation to prevent the separation of the platoon, and the change of formation does not require a change to have fewer columns. For example, depending on the number of lanes, traffic conditions, etc., the formation of the platoon may be appropriately changed.

In operation 307, the first electronic device 310 may distinguish the vehicles 10 into a first group including the leading vehicle 11 and a second group including only following vehicles 12 based on the second formation.

For example, when executing the instructions stored in the memory 120, the processor 110 may distinguish the vehicles 10 into a plurality of groups to change the formation based on the second formation. The plurality of groups may be determined based on the columns of the second formation.

For example, when the vehicles 10 forming the platoon include six vehicles and the second formation includes two columns, the processor 110 may distinguish the vehicles 10 into a first group of three vehicles and a second group of three vehicles. Referring to 400b of FIG. 4, when the second formation includes two columns, the processor 110 may distinguish the vehicles 10 into a first group and a second group respectively corresponding to the two columns.

For example, the first group may include the leading vehicle 11. The first group may include only the leading vehicle 11, or may include the leading vehicle 11 and some of the following vehicles 12. In the example shown in FIG. 4, the first group may include the leading vehicle 11, a first vehicle 12-1, and a second vehicle 12-2.

For example, the second group may include only the following vehicles 12. Since the leading vehicle 11 is included in the first group, the second group may be a group of vehicles composed of only the following vehicles 12. In the example shown in FIG. 4, the second group may include a third vehicle 12-3, a fourth vehicle 12-4, and a fifth vehicle 12-5. The processor 110 may distinguish the vehicles 10 into a first group including the leading vehicle 11, the first vehicle 12-1, and the second vehicle 12-2, and a second group including the third vehicle 12-3, the fourth vehicle 12-4, and the fifth vehicle 12-5, based on the second formation.

In operation 308, the first electronic device 310 may transmit a signal for moving the second group to the second lane 42 to the following vehicles 12 included in the second group.

For example, when executing the instructions stored in the memory 120, the processor 110 may transmit signals for driving control of the following vehicles 12 to the following vehicles 12-3, 12-4, and 12-5 to move the following vehicles (e.g., third vehicle 12-3, fourth vehicle 12-4, and fifth vehicle 12-5) included in the second group to the second lane 42 using wireless communication device 130. The signal for driving control may be provided by the first electronic device 310. Referring to FIG. 4, the first electronic device 310 may transmit the signal so that, among the following vehicles 12, the following vehicles (e.g., the first vehicle 12-1 and the second vehicle 12-2) included in the second group do not change the lane, and the following vehicles 12-3, 12-4, and 12-5 included in the second group drive on the second lane 42.

According to an embodiment, the data packet of the signal may include a target identifier indicating the vehicles 10 to receive the signal. For example, a unique identifier may be assigned to each of the following vehicles 12. The target identifier may include identifiers allocated to the following vehicles 12-3, 12-4, and 12-5 included in the second group. Since the target identifier is included in the data packet of the signal, the following vehicles 12-2 and 12-3 included in the first group may maintain the driving of the first lane 41 through the target identifier included in the data packet of the signal even if the signal is received. However, the disclosure is not limited. Alternatively, the first electronic device 310 may transmit the signal using the characteristics of the signal, such as the frequency, amplitude, and phase of the signal, so that only the following vehicles 12-3, 12-4, and 12-5 included in the second group may move.

According to an embodiment, the following vehicles 12-3, 12-4, and 12-5 included in the second group may move from the first lane 41 to the second lane 42 based on the reception of the signal. As shown in 400b of FIG. 4, the formation of the platoon may be changed from the first to the second formation as the following vehicles 12-3, 12-4, and 12-5 move to the second lane 42.

According to an embodiment, the change in the formation may be performed while the vehicles 10 wait for a signal of the traffic light 50. For example, the processor 110 may transmit a signal for moving the second group to the second lane 42 to the following vehicles 12-3, 12-4, and 12-5 included in the second group while the vehicles 10 are stopped by a stop signal (e.g., a red signal) of the traffic light 50. While the vehicles 10 wait by the stop signal of the traffic light 50, the following vehicles 12-3, 12-4, and 12-5 included in the second group may move to the second lane 42.

According to an embodiment, the first electronic device 310 may be configured to transmit a signal for moving the second group to the second lane 42 when the waiting time of the signal of the traffic light 50 is longer than the time required to move the following vehicles 12-3, 12-4, and 12-5 included in the second group. For example, the processor 110 may obtain first time information related to the remaining time of the stop time of the traffic light 50 from an external electronic device (e.g., a base station and/or a satellite), the traffic light 50, and/or a navigation application.

According to an embodiment, the processor 110 may calculate second time information related to the time required to change the first formation to the second formation. For example, the second time information may be calculated based on the time required for the following vehicles 12-3, 12-4, and 12-5 included in the second group to move from the first lane 41 to the second lane 42. For example, the processor 110 may calculate the second time information based on the number, speed, and/or moving distance of the following vehicles 12-3, 12-4, and 12-5 included in the second group.

According to an embodiment, the processor 110 may be configured to compare the first time information with the second time information and transmit a signal for moving the second group to the second lane 42 based on the second time information shorter than the first time information. For example, when the second time information is longer than the first time information, if the stop signal changes to the progress signal (e.g., a green signal) while the following vehicles 12-3, 12-4, and 12-5 included in the second group move, traffic congestion or traffic accidents may occur due to the lane change. When the second time information is shorter than the first time information, traffic congestion or traffic accident may be prevented because the following vehicles 12-3, 12-4, and 12-5 included in the second group may move from the first lane 41 to the second lane 42 before the stop signal is changed into the progress signal. According to an embodiment, the processor 110 may move the second group to the second lane 42 based on the remaining time of the stop signal of the traffic light 50 and the time required for lane change.

The example described through FIGS. 3 and 4 has been described under the assumption that no other vehicle 20 is present on the second lane 42, but operations for changing the formation may be performed even when another vehicle 20 is present on the second lane 42. Hereinafter, exemplary operations for changing the formation when another vehicle 20 is present on the second lane 42 are described.

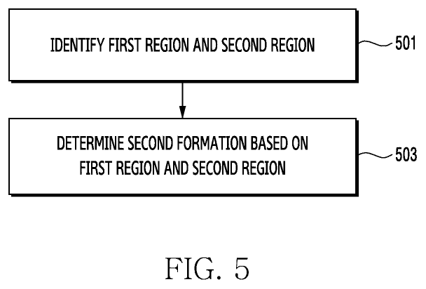

FIG. 5 is a flowchart illustrating operations of an electronic device for changing the formation of a platoon when another vehicle is present. FIG. 6 schematically illustrates a process of changing the formation of a platoon by the operations of FIG. 5.

The operations described in FIG. 5 may be operations of an electronic device (e.g., the electronic device 100 of FIG. 1) that are caused when instructions stored in the memory (e.g., the memory 120 of FIG. 2) are executed by the processor (e.g., the processor 110 of FIG. 1).

Referring to FIG. 5, in operation 501, the electronic device 100 may identify a first region (e.g., the first region 611 of FIG. 6) and a second region (e.g., the second region 612 of FIG. 6) of a second lane (e.g., the second lane 42 of FIG. 6).

For example, when executing the instructions stored in the memory 120, the processor 110 may identify the first region 611 of the second lane 42 that is at least partially empty and the second region 612 of the second lane 42 occupied by another vehicle (e.g., another vehicle 20 of FIG. 6) on the second lane 42. For example, the processor 110 may determine whether the first region 611 on the second lane 42 has been occupied by another vehicle or the like by performing object detection on the image obtained through the camera 140.

600a of FIG. 6 illustrates vehicles 10 platooning in the first large, which is a formation before being changed. For example, the first formation may be constituted of six rows and one column. Referring to FIG. 6, another vehicle 20 may be located on the second lane 42. For example, the other vehicle 20 may be located next to the leading vehicle 11. When the other vehicle 20 is located on the second lane 42, the second formation may be determined considering the region of the second lane 42 occupied by the other vehicle 20.

According to an embodiment, the processor 110 may distinguish the second lane 42 into a first region 611 and a second region 612. The first region 611 may be an empty portion of the second lane 42 and may be a region of the second lane 42 that is not occupied by the other vehicle 20. For example, when there is no other vehicle 20 next to the following vehicles 12, the processor 110 may identify the empty first region 611 based on the second environment information.

For example, the second region 612 is another portion of the second lane 42 occupied by the other vehicle 20 on the second lane 42 and may be a region of the second lane 42 that is not empty. According to an embodiment, the processor 110 may identify the other vehicle 20 located next to the leading vehicle 11 through the first environment information. For example, the camera 140 may capture an image including the other vehicle 20 located next to the leading vehicle 11. The processor 110 may identify the presence of the other vehicle 20 from the image. However, the disclosure is not limited thereto. For example, when the location of the other vehicle 20 is located in the first angle of view 411 of the first camera 140 and the second angle of view 412 of the camera 240, the other vehicle 20 may appear in the image captured by the camera 240. In this case, the processor 110 may identify the presence of the other vehicle 20 through the first environment information and the second environment information. The processor 110 may identify the first region 611 and the second region 612 based on the first environment information and/or the second environment information. The processor 110 may obtain second information indicating that a portion of the second lane 42 has been occupied by the other vehicle 20 based on identifying the first region 611 and the second region 612.

In operation 503, the electronic device 100 may determine the second formation based on the first region 611 and the second region 612.

For example, when executing the instructions stored in the memory 120, the processor 110 may determine a second formation to move the second group onto the first region 611 of the second lane 42 based on the first region 611 and the second region 612. When the other vehicle 20 is located on the second lane 42, if the platoon is changed into the second formation vehicle shown in 400b of FIG. 4, the following vehicle (e.g., the third vehicle) in the second group may collide with the other vehicle 20. The processor 110 may determine the second formation based on the first region 611 and the second region 612 so that the collision does not occur.

600b of FIG. 6 illustrates vehicles 10 platooning in a second formation, which is a formation after the change. Referring to FIG. 6, the processor 110 may determine the second formation so that the second group moves to the first region 611 that is not occupied by the other vehicle 20. For example, the second formation may be determined so that the following vehicles 12 (e.g., the third vehicle, the fourth vehicle, and the fifth vehicle) included in the second group are located behind the other vehicle 20 on the second lane 42. For example, the second formation is constituted of four rows and two columns (e.g., 4×2), but vehicles 10 may not be located in the next site (first row, second column) to the leading vehicle 11 and a back site (fourth row, first column) of the first group. According to an embodiment, the processor 110 may change the second formation to a formation suitable for real-time traffic conditions by determining the second formation considering the location of the other vehicle 20 on the second lane 42.

Although not shown, when the other vehicles 20 are more or the same in number as the vehicles (e.g., leading vehicle 11, first vehicle 12-1, and second vehicle 12-2) included in the first group, if the second group moves behind the other vehicles 20, the second formation after the change may spread more widely than the first formation before the change. If the second formation is spread wider than the first formation, the platoon may be easily separated, so that the processor 110 may maintain the first formation without changing it. According to an embodiment, the processor 110 may be configured to maintain the first formation based on identifying that the second lane 42 is not empty but is occupied by the other vehicle 20.

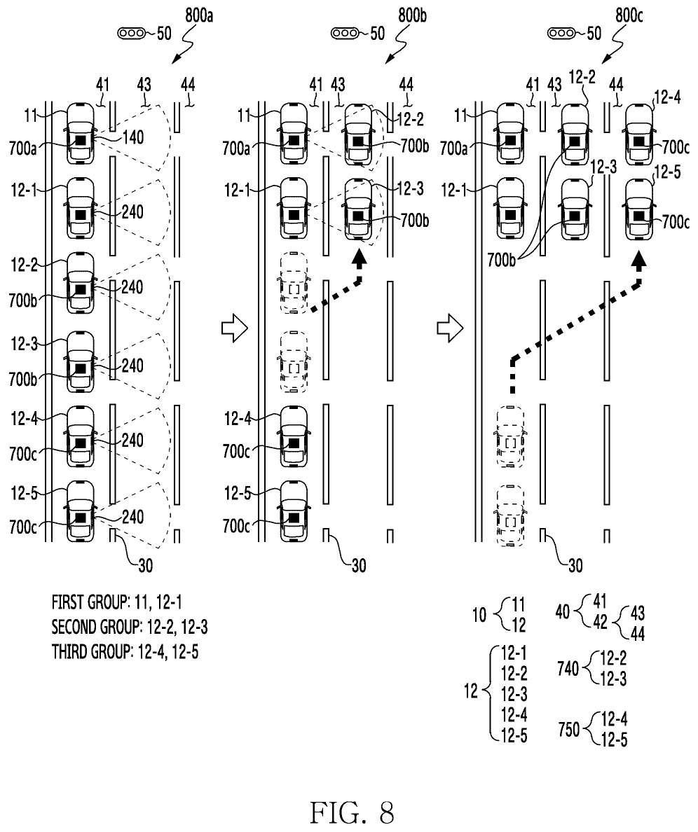

The examples described through FIGS. 3, 4, 5, and 6 have been described under the assumption that the second lane 42 includes only one lane, but the operations for changing the formation may be performed even when the second lane 42 includes a plurality of lanes (e.g., the third lane 43 and the fourth lane 44 of FIG. 8). Hereinafter, exemplary operations of changing the formation when the second lane 42 includes a plurality of lanes are described.

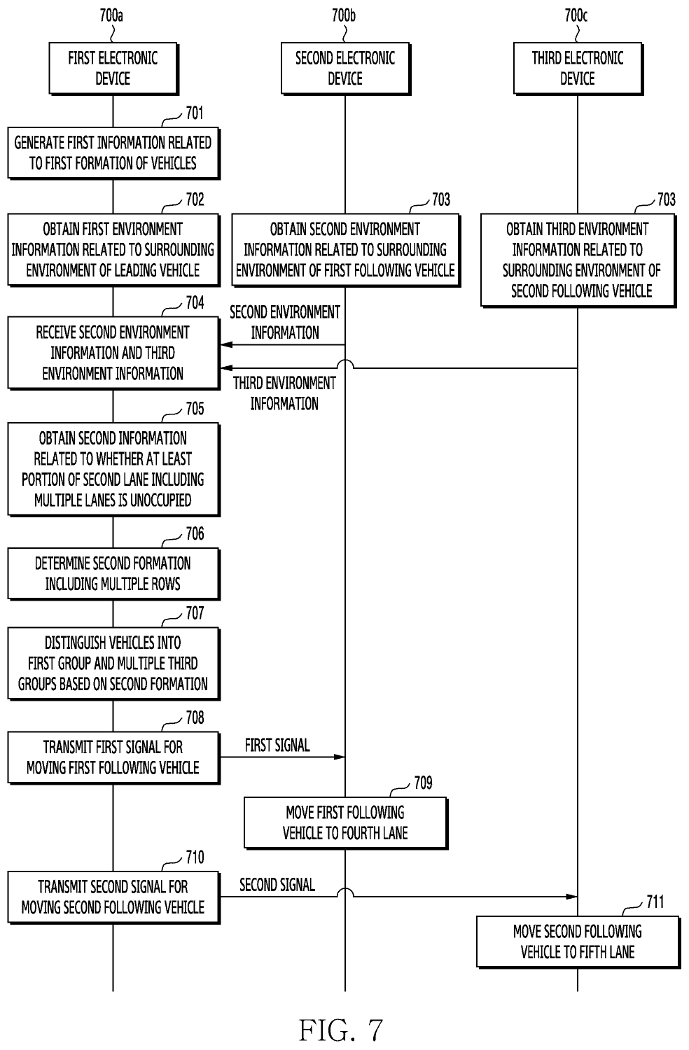

FIG. 7 is a flowchart illustrating operations of an electronic device for changing the formation of a platoon when a second lane includes a plurality of lanes. FIG. 8 schematically illustrates a process of changing the formation of a platoon by the operations of FIG. 7.

The operations described in FIG. 7 may be operations of an electronic device (e.g., the electronic device 100 of FIG. 2) that are caused when instructions stored in the memory (e.g., the memory 120 of FIG. 2) are executed by the processor (e.g., the processor 110 of FIG. 2). In the following description, the electronic device 100 disposed in the leading vehicle (e.g., the leading vehicle 11 of FIG. 2) is referred to as a first electronic device 700a, and other electronic devices 200 disposed in the following vehicles (e.g., the following vehicles of FIG. 1) are referred to as a second electronic device 700b and a third electronic device 700c.

According to an embodiment, when the second lane 42 includes a plurality of lanes (e.g., the third lane 43 and the fourth lane 44 of FIG. 8), the first electronic device 700a may distinguish at least some of the following vehicles 12 into a plurality of third groups (e.g., a fourth group and a fifth group). For example, the fourth group may be referred to as a group of the first following vehicle 740 moving to the third lane 43 when changed into the second formation, and the fifth group may be referred to as a group of the second following vehicle 750 moving to the fourth lane 44 when changed into the second formation. The second electronic device 700b may be an electronic device disposed in the first following vehicle 740, and the third electronic device 700c may be an electronic device disposed in the second following vehicle 750. One or more second electronic devices 700b and/or one or more third electronic devices 700c may be provided.

Referring to FIG. 7, in operation 701, the first electronic device 700a may identify first information related to the first formation of the vehicles 10 forming the platoon.

Operation 701 described in FIG. 7 may correspond to operation 301 described in FIG. 3. For example, when executing instructions stored in the memory 120, the processor 110 may obtain first information related to the first formation of the vehicles 10. The first formation may be referred to as a formation of the platoon before being changed. 800a of FIG. 8 illustrates vehicles 10 platooning in the first large, which is a formation before being changed. Referring to 800a of FIG. 8, when the vehicles 10 include the leading vehicle 11 and five following vehicles 12 (e.g., first vehicle 12-1, second vehicle 12-2, third vehicle 12-3, fourth vehicle 12-4, and/or fifth vehicle 12-5), the first formation may be constituted of six rows and one column (e.g., 6×1). Referring to FIG. 8, the second lane 42 may include a third lane 43 and a fourth lane 44.

In operation 702, the first electronic device 700a may obtain first environment information related to the surrounding environment of the leading vehicle 11.

Operation 702 described in FIG. 7 may correspond to operation 302 described in FIG. 3. For example, when executing instructions stored in the memory 120, the processor 110 may obtain first environment information related to the surrounding environment of leading vehicle 11 based on an image obtained from the camera (e.g., the camera 140 of FIG. 2). For example, the first electronic device 700a may identify an external object, such as the other vehicle 20, line 30, lane 40, and/or traffic light 50, around the leading vehicle 11 through a neural network model pre-trained to identify the external object from an image corresponding to the external object.

In operation 703, the second electronic device 700b and the third electronic device 700c may obtain second environment information and third environment information, respectively, related to the surrounding environment of the following vehicles 12.

Operation 703 described in FIG. 7 may correspond to operation 303 described in FIG. 3. For example, when executing the instructions stored in the memory (e.g., the memory 220 of FIG. 2), the processor (e.g., the processor 210 of FIG. 2) may obtain second environment information related to the surrounding environment of each of the following vehicles 12 based on the image obtained from the camera (e.g., the camera 240 of FIG. 2). For example, the second electronic device 700b may obtain information (e.g., second environment information) about the surrounding environment of the first following vehicle 740, and the third electronic device 700c may obtain information (e.g., third environment information) about the surrounding environment of the second following vehicle 750.

In operation 704, the first electronic device 700a may receive, from the following vehicles 12, second environment information and third environment information related to the surrounding environment of the following vehicles 12.

Operation 704 described in FIG. 7 may correspond to operation 304 described in FIG. 3. For example, when executing the instructions stored in the memory 120, the processor 110 may receive data including second environment information and data including third environment information transmitted from the wireless communication device 230 through the wireless communication device 130.

In operation 705, the first electronic device 700a may obtain second information related to whether at least a portion of the second lane 42 including a plurality of lanes is empty.

For example, when executing the instructions stored in the memory 120, the processor 110 may obtain second information related to whether at least portion of the third lane 43 and at least portion of the fourth lane 44 are empty based on the first environment information, the second environment information, and the third environment information. Referring to FIG. 8, the third lane 43 may be a lane adjacent to the first lane 41, and the fourth lane 44 may be a lane adjacent to the third lane 43. For example, when the first formation is constituted of six rows and one column and drives on the left lane, the third lane 43 may be the middle lane, and the fourth lane 44 may be the right lane.

According to an embodiment, the first electronic device 700a may obtain second information related to whether at least a portion of the third lane 43 and at least a portion of the fourth lane 44 are empty based on the first environment information, the second environment information, and the third environment information. For example, when no other vehicle 20 is located on the third lane 43 and the fourth lane 44, since there is no image corresponding to the other vehicle 20 in the images obtained through the camera 140 and the camera 240, the first electronic device 700a may obtain second information indicating that the third lane 43 and the fourth lane 44 are empty based on the first environment information and the second environment information.

In operation 706, the first electronic device 700a may determine a second formation including a plurality of rows.

For example, when executing the instructions stored in the memory 120, the processor 110 may determine the second formation including a first column corresponding to the first lane 41 and a plurality of second rows respectively corresponding to the plurality of lanes based on identifying the second lane 42 including a plurality of lanes at least some of which are empty.

800c of FIG. 8 illustrates vehicles 10 platooning in a second formation, which is a formation after the change. According to an embodiment, the first electronic device 700a may determine the second formation according to the number of lanes. For example, when the second lane 42 includes two lanes (e.g., third lane 43 and fourth lane 44), the processor 110 may determine a second formation including a plurality of rows corresponding to the first lane 41, third lane 43, and fourth lane 44. The second formation may include a first column and a plurality of second columns (e.g., a third column and a fourth column). The first column may correspond to the first lane 41. The third column may correspond to the third lane 43. The fourth column may correspond to the fourth lane 44.

In operation 707, the first electronic device 700a may distinguish the vehicles 10 into a first group including the leading vehicle 11 and a plurality of third groups including only the following vehicles 12 based on the second formation.

For example, when executing the instructions stored in the memory 120, the processor 110 may distinguish the vehicles 10 into a plurality of groups to change the formation based on the second formation.

For example, when the vehicles 10 forming the platoon include six vehicles and include three columns (e.g., first, third, and fourth columns) of the second formation, the processor 110 may assign each two of the vehicles 10 to the first, fourth, and fifth groups. Referring to 800c of FIG. 8, when the second formation includes three columns (e.g., first, third, and fourth columns), the processor 110 may distinguish the vehicles 10 into three groups respectively corresponding to the three columns.

For example, the processor 110 may distinguish the vehicles 10 into a first group, a fourth group, and a fifth group. The first group is a group of vehicles corresponding to the first column of the second formation to be changed, and may include the leading vehicle 11. The first group may be a group of vehicles that maintain the driving on the first lane 41. The fourth group may be a group of at least one following vehicle (e.g., the first following vehicle 740) corresponding to the third column of the second formation to be changed. The fourth group may include a first following vehicle 740 moving from the first lane 41 to the third lane 43. The fifth group may be a group of at least one following vehicle (e.g., the second following vehicle 750) corresponding to the fourth column of the second formation to be changed. The fifth group may include a second following vehicle 750 moving from the first lane 41 to the fourth lane 44. Referring to FIG. 8, the first vehicle 12-1 may be included in the first group. The first following vehicle 740 included in the fourth group may include a second vehicle 12-2 and a third vehicle 12-3. The second following vehicle 750 included in the fifth group may include a fourth vehicle 12-4 and a fifth vehicle 12-5.

In operation 708, the first electronic device 700a may transmit a first signal for moving the first following vehicle 740 to the third lane 43 to the first following vehicle 740.

For example, when executing the instructions stored in the memory 120, the processor 110 may transmit, to the first following vehicle 740, a signal for driving control of the first following vehicle 740 to move the first following vehicles 740 (e.g., the second vehicle 12-2 and the third vehicle 12-3) included in the fourth group to the fourth lane 44 using the wireless communication device 130. As described above, the data packet of the first signal may include a target identifier indicating the first following vehicle 740 that will receive the first signal. The second electronic device 700b may receive a first signal from the first electronic device 700a.

In operation 709, the second electronic device 700b may control the first following vehicle 740 to move the first following vehicle 740 from the first lane 41 to the third lane 43 based on the reception of the first signal. 800b of FIG. 8 illustrates a process of changing from the first formation to the second formation. As shown in 800b of FIG. 8, the first following vehicle 740 may move from the first lane 41 to the third lane 43. As the first following vehicle 740 moves to the third lane 43, the first formation may be changed. While the first following vehicle 740 moves to the third lane 43, the processor 110 may control the second following vehicle 750 to be located on the first lane 41 without moving. For example, in a case where waiting for a signal of the traffic light 50, when the first following vehicle 740 moves to the third lane 43, the second following vehicle 750 may wait without moving.

In operation 710, the first electronic device 700a may transmit a second signal for moving the second following vehicle 750 to the fourth lane 44 to the second following vehicle 750.

For example, when executing the instructions stored in the memory 120, the processor 110 may transmit, to the second following vehicle 750, a signal for driving control of the second following vehicle 750 to move the second following vehicles 750 (e.g., the fourth vehicle 12-4 and the fifth vehicle 12-5) included in the fifth group to the fourth lane 44 using the wireless communication device 130. As described above, the data packet of the second signal may include a target identifier indicating the second following vehicle 750 that will receive the second signal. The third electronic device 700c may receive a second signal from the first electronic device 700a.

According to an embodiment, the processor 110 may be configured to transmit a second signal to the second following vehicle 750 after the movement of the first following vehicle 740 is completed. For example, while the first following vehicle 740 moves from the first lane 41 to the third lane 43, the second electronic device 700b may transmit second environment information, which is information about the surrounding environment of the first following vehicle 740, to the first electronic device 700a. The second electronic device 700b may transmit a signal indicating the completion of the movement to the first electronic device 700a based on the completion of the movement of the first following vehicle 740 to the third lane 43. When the first following vehicle 740 is located on the third lane 43, the processor 110 may identify whether the fourth lane 44 adjacent to the third lane 43 is empty based on the second environment information received from the second electronic device 700b. The processor 110 may transmit a second signal for moving the second following vehicle 750 to the fourth lane 44 based on identifying the fourth lane 44 that is at least partially empty.

In operation 711, the third electronic device 700c may control the second following vehicle 750 to move the second following vehicle 750 from the first lane 41 to the fourth lane 44 based on the reception of the second signal. As shown in 800c of FIG. 8, the second following vehicle 750 may move from the first lane 41 to the fourth lane 44. As the second following vehicle 750 moves to the fourth lane 44, the first formation may be changed into the second formation.

According to an embodiment, the processor 110 may determine the second formation based on the number of available lanes to allow the vehicles 10 to platoon in a formation for preventing separation of the platoon. For example, as in the example illustrated in FIG. 4, when the second lane 42 includes only one lane, the processor 110 may determine a second formation including two columns. For example, when the second lane 42 includes a plurality of lanes, as illustrated in FIG. 8, the processor 110 may determine a second formation including a plurality of columns (e.g., first and second columns) corresponding to the plurality of lanes. According to an embodiment, since the first electronic device 700a may change the platoon according to the road circumstance, separation of the platoon may be reduced while driving.

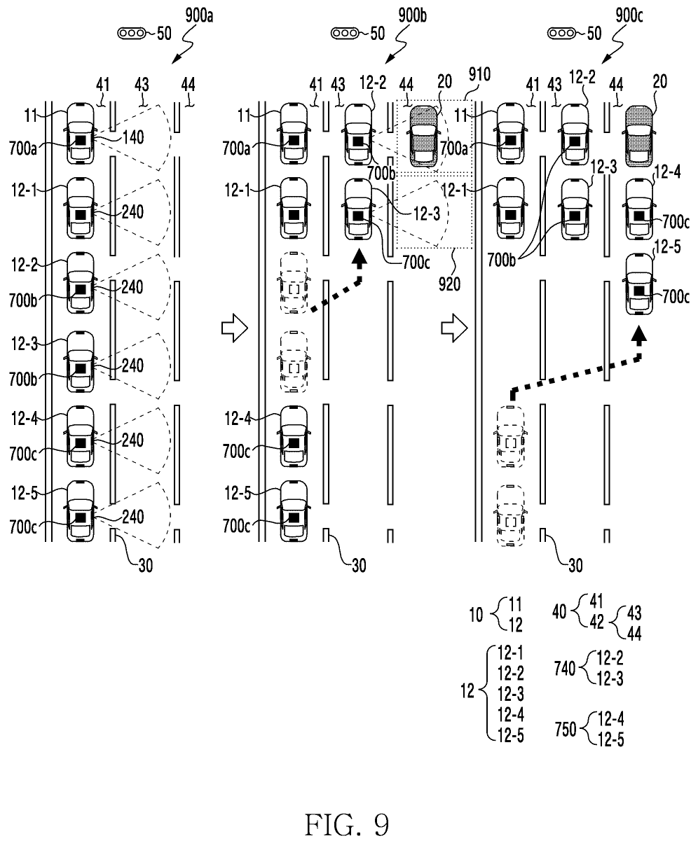

FIG. 9 schematically illustrates a process of changing the formation of a platoon.

The descriptions made with reference to FIGS. 6 and 7 may apply, in

substantially the same manner, to the case where the second lane 42 includes a plurality of lanes.

Referring to FIG. 9, when the second lane 42 includes a plurality of lanes (e.g., the third lane 43 and the fourth lane 44), the vehicles 10 may be distinguished into a first group 11 and 12-1 including the leading vehicle 11, a fourth group 12-2 and 12-3 including a first following vehicle 740, and a fifth group 12-4 and 12-5 including a second following vehicle 750. When the formation of the platoon changes from the first formation to the second formation, the first group may be located on the first lane 41, the fourth group may move from the first lane 41 to the third lane 43, and the fifth group may move from the first lane 41 to the fourth lane 44.

900a of FIG. 9 illustrates vehicles 10 platooning in the first large, which is a formation before being changed. 900b of FIG. 9 illustrates a process of changing from the first formation to the second formation. Referring to 900a and 900b of FIG. 9, the processor (e.g., the processor 110 of FIG. 2) may control the second following vehicle 750 to be located on the first lane 41 by not moving while the first following vehicle 740 is moving. The processor 110 may receive second environment information about the surrounding environment of the first following vehicle 740 from the first following vehicle 740, and identify whether the fourth lane 44 is empty based on the second environment information.

For example, another vehicle 20 may move to the side of the first following vehicle 740 after the first following vehicle 740 moves to the third lane 43 and before the second following vehicle 750 moves to the fourth lane 44. In this case, the second electronic device 700b of the first following vehicle 740 may obtain an image including the other vehicle 20 through a camera (e.g., the camera 240 of FIG. 2) and identify the other vehicle 20 from the image. The second electronic device 700b may transmit second environment information indicating that the other vehicle 20 is located on the fourth lane 44 to the first electronic device 700a. The processor 110 may distinguish the fourth lane 44 into a first region 910 and a second region 920 based on the second environment information. For example, the first region 910 may be an empty portion of the fourth lane 44 and may be a region of the fourth lane 44 that is not occupied by the other vehicle 20. For example, the second region 920 is another portion of the fourth lane 44 occupied by the other vehicle 20 on the fourth lane 44 and may be a region of the fourth lane 44 that is not empty.

According to an embodiment, the processor 110 may identify the presence of the other vehicle 20 on the fourth lane 44 based on the second environment information received from the second electronic device 700b disposed in the first following vehicle 740 located on the third lane 43. According to an embodiment, when executing the instructions stored in the memory (e.g., the memory 120 of FIG. 2), the processor 110 may again determine the second formation for moving the fifth group onto the first region 910 of the fourth lane 44 based on the first region 910 and the second region 920.

900c of FIG. 9 illustrates vehicles 10 platooning in a second formation, which is a formation after the change. Referring to 900c of FIG. 9, the processor 110 may again determine the second formation so that the fifth group moves to the first region 910 that is not occupied by the other vehicle 20. For example, the second formation may be determined so that the following vehicles (e.g., the fourth vehicle 12-4 and the fifth vehicle 12-5) included in the fifth group are located behind the other vehicle 20 on the fourth lane 44. For example, the second formation is constituted of three rows and three columns (e.g., 3×3), but vehicles 10 may not be located in the site (first row, third column) in front of the fourth vehicle 12-4 and a back site (third row, first column) of the first group. According to an embodiment, the processor 110 may change the second formation to a formation suitable for real-time traffic conditions by determining the second formation considering the location of the other vehicle 20 on the road.

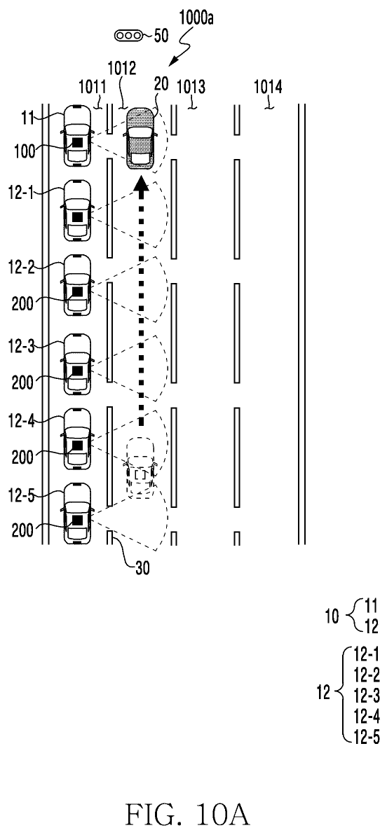

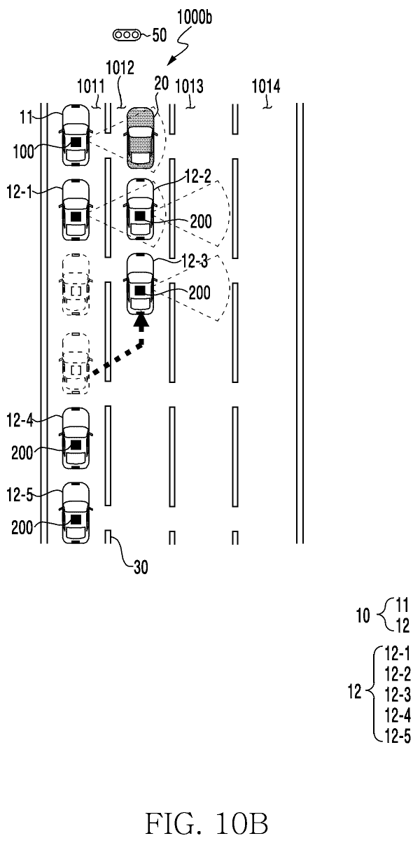

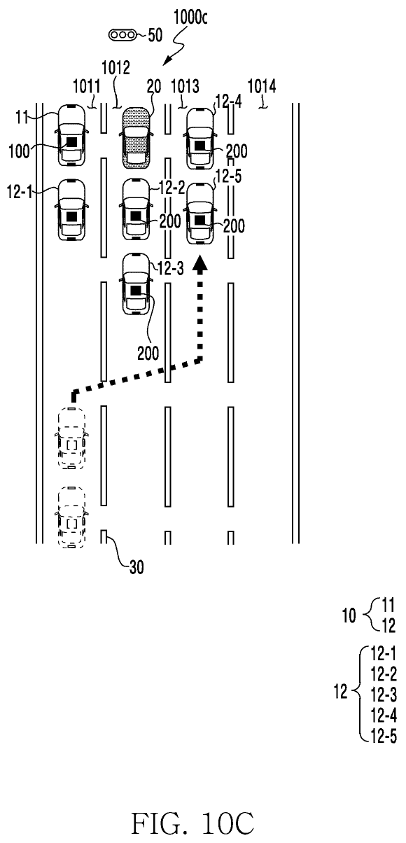

FIGS. 10A, 10B, and 10C illustrate an example of a process of generating a local map based on environment information received from vehicles by an electronic device according to an embodiment.

The electronic device 100 according to an embodiment may obtain environment information (e.g., first environment information) related to the environment around the leading vehicle 11 through the camera 140. The second electronic devices 200 may obtain environment information (e.g., second environment information) related to the environment around the following vehicles 12 through the camera 240. The second electronic devices 200 may transmit data including the second environment information to the first electronic device 100. The electronic device 100 according to an embodiment may generate a local map for representing the surrounding environment of the platooning vehicles 10 based on the first environment information and the second environment information, and determine the second formation based on the local map. The local map may be referred to as a map for the surrounding environment of the platooning vehicles 10.

FIG. 10A illustrates vehicles 10 platooning in the first large, which is a formation before being changed.

Referring to FIG. 10A, vehicles 10 platooning in the first formation including one column may be located on the first lane 1011. Each of the vehicles 10 may obtain an image of the surrounding environment using a camera (e.g., the camera 140 of FIG. 2) or a camera (e.g., the camera 240 of FIG. 2) and identify an external object (e.g., another vehicle 20, line 30, lane 40, and/or traffic light 50) from the image to obtain information related to the surrounding environment. For example, the second electronic devices 200 disposed in the following vehicles 12 may transmit second environment information related to the environment around the following vehicles 12 to the first electronic device 100. The first electronic device 100 may generate a local map for the surrounding environment of the space where the vehicles 10 are located by combining the first environment information and the second environment information. For example, the local map may include information about the current location of the vehicles 10 and external object around the vehicles 10. The current location of the vehicles 10 may be identified using a GPS sensor (e.g., the GPS sensor 150 of FIG. 2) and/or a GPS sensor (e.g., the GPS sensor 250 of FIG. 2).

According to an embodiment, the local map may include real-time environment information. For example, the first environment information and second environment information may be obtained in real-time, and the first electronic device 100 may generate a local map indicating a real-time circumstance based on the first and second environment information obtained in real-time. For example, the local map may include information indicating the other vehicle 20 located next to the leading vehicle 11.

FIG. 10B illustrates a process of changing from the first formation to the second formation. Referring to FIG. 10B, the second vehicle 12-2 and the third vehicle 12-3 may move to the second lane 1012 adjacent to the first lane 1011 for the formation of the platoon to be changed into the second formation. For example, while waiting for a signal of the traffic light 50, the formation of the platoon may be changed. While the second vehicle 12-2 and the third vehicle 12-3 are moving, the fourth vehicle 12-4 and the fifth vehicle 12-5 may not move but may be located on the first lane 1011. If the second vehicle 12-2 and the third vehicle 12-3 move to the second lane 1012, the second vehicle 12-2 and the third vehicle 12-3 may be adjacent to the third lane 1013. The camera 240 of the second vehicle 12-2 may capture the surroundings of the second vehicle 12-2, and the camera 240 of the third vehicle 12-3 may capture the surroundings of the third vehicle 12-3. For example, the second environment information provided in real-time may include information related to the third lane 1013 according to the movement of the second vehicle 12-2 and the third vehicle 12-3. For example, information related to the third lane 1013 may be referred to as information indicating whether the third lane 1013 is empty or occupied by another vehicle.

FIG. 10C illustrates vehicles 10 platooning in a second formation, which is a formation after the change. Referring to FIG. 10C, the fourth vehicle 12-4 and the fifth vehicle 12-5 may change the formation of the platoon from the first formation to the second formation by moving to the third lane 1013. The third lane 1013 may be adjacent to the fourth lane 1014. The camera 240 of the fourth vehicle 12-4 may capture the surroundings of the fourth vehicle 12-4, and the camera 240 of the fifth vehicle 12-5 may capture the surroundings of the fifth vehicle 12-5. According to an embodiment, the second environment information provided in real-time may include information related to the fourth lane 1014 according to the movement of the fourth vehicle 12-4 and the fifth vehicle 12-5.

According to an embodiment, since the second environment information obtained in real-time may differ depending on the formation of the platoon, the processor 110 may generate a local map based on the second environment information obtained in real-time. Since the local map may represent information about the surrounding environment of the platooning vehicles 10, the processor 110 may determine the formation of the platoon or control the driving of the platooning vehicles 10 based on real-time information. Since the local map reflecting real-time information may reflect various circumstances that may occur on the road, the processor 110 may control platooning based on the local map.

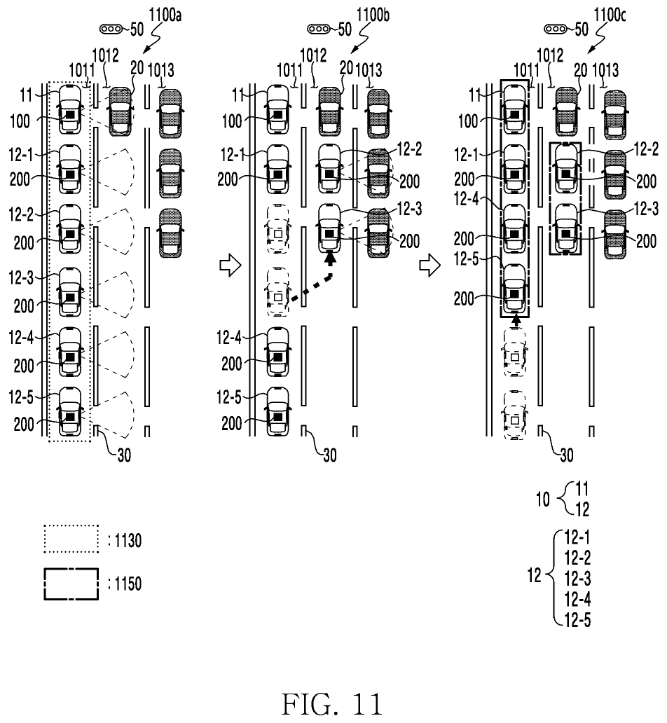

FIG. 11 illustrates another example of a process of generating a local map based on environment information received from vehicles by an electronic device according to an embodiment.

1100a of FIG. 11 illustrates vehicles 10 platooning in the first large, which is a formation before being changed. 1100b of FIG. 11 illustrates a process of changing from the first formation to the second formation. 1100c of FIG. 11 illustrates vehicles 10 platooning in a second formation, which is a formation after the change.

Referring to 1100a of FIG. 11, since the first formation 1130 includes one column, the first environment information and the second environment information may not accurately reflect the circumstance of the third lane 1013 spaced apart from the first lane 1011. Referring to 1100b of FIG. 11, as the second vehicle 12-2 and the third vehicle 12-3 move to the second lane 1012, the camera 240 of the second vehicle 12-2 may capture the surroundings of the second vehicle 12-2, and the camera 240 of the third vehicle 12-3 may capture the surroundings of the third vehicle 12-3. For example, the second environment information provided in real-time may include information related to the other vehicle 20 located on the third lane 1013 according to the movement of the second vehicle 12-2 and the third vehicle 12-3. The local map generated in real-time may represent information related to the other vehicle 20 located on the fourth lane 1014.

Referring to 1100c of FIG. 11, the second formation 1150 may be determined based on a real-time circumstance. For example, since the other vehicle 20 is located on the third lane 1013, the processor 110 may determine the second formation 1150 so that the fourth vehicle 12-4 and the fifth vehicle 12-5 are located behind the leading vehicle 11. According to an embodiment, since the local map may represent real-time information about the road, the formation of the platoon may be appropriately changed based on real-time information about the road. The electronic device 100 according to an embodiment may control platooning in a formation suitable for real-time information using a neural network model.

The electronic device 100 according to an embodiment may reduce a circumstance in which the platoon is separated according to waiting for a signal by appropriately changing the formation of the platoon. In a case where vehicles 10 wait for a signal and depart, it is possible to allow the vehicles 10 to depart more quickly by changing the formation of the platoon.

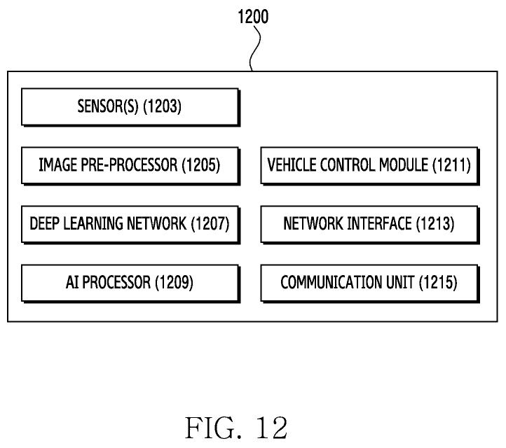

FIG. 12 is an example block diagram illustrating an autonomous driving system of a vehicle according to an embodiment.

The autonomous driving system 1200 of the vehicle according to FIG. 12 may be a deep learning network including sensors 1203, an image preprocessor 1205, a deep learning network 1207, an artificial intelligence (AI) processor 1209, a vehicle control module 1211, a network interface 1213, and a communication unit 1215. In various embodiments, each element may be connected via a variety of interfaces. For example, sensor data detected and output by the sensors 1203 may be fed to the image preprocessor 1205. The sensor data processed by the image preprocessor 1205 may be fed to the deep learning network 1207 run on the AI processor 1209. An output of the deep learning network 1207 run by the AI processor 1209 may be fed to the vehicle control module 1211. Intermediate results of the deep learning network 1207 run on the AI processor 1209 may be fed to the AI processor 1209. In various embodiments, the network interface 1213 communicates with an electronic device in the vehicle to transmit autonomous driving route information and/or autonomous driving control commands for autonomous driving of the vehicle to its internal block components. In an embodiment, the network interface 1213 may be used to transmit sensor data obtained through the sensor(s) 1203 to an external server. In some embodiments, the autonomous driving control system 1200 may include additional or fewer components as appropriate. For example, in some embodiments, the image preprocessor 1205 may be an optional component. As another example, a post-processing element (not shown) may be included in the autonomous driving control system 1200 to perform post-processing of the output of the deep learning network 1207 before the output is provided to the vehicle control module 1211.

In some embodiments, the sensors 1203 may include one or more sensors. In various embodiments, the sensors 1203 may be attached to various different positions of the vehicle. The sensors 1203 may be arranged to face one or more different directions. For example, the sensors 1203 may be attached to the front, sides, rear, and/or roof of the vehicle to face directions such as forward-facing, rear-facing, side-facing and the like. In some embodiments, the sensors 1203 may be image sensors such as e.g., high dynamic range cameras. In some embodiments, the sensors 1203 may include non-visual sensors. In some embodiments, the sensors 1203 may include a radar, a light detection and ranging (LiDAR), and/or ultrasonic sensors in addition to the image sensor. In some embodiments, the sensors 1203 are not mounted on the vehicle having the vehicle control module 1211. For example, the sensors 1203 may be incorporated as a part of a deep learning system for capturing sensor data and may be installed onto an environment or a roadway and/or mounted on surrounding vehicles.

In some embodiments, the image preprocessor 1205 may be used to preprocess sensor data of the sensors 1203. For example, the image preprocessor 1205 may be used to preprocess sensor data to split sensor data into one or more components, and/or to post-process the one or more components. In some embodiments, the image preprocessor 1205 may be any one of a graphics processing unit (GPU), a central processing unit (CPU), an image signal processor, or a specialized image processor. In various embodiments, the image preprocessor 1205 may be a tone-mapper processor for processing high dynamic range data. In some embodiments, the image preprocessor 1205 may be a component of the AI processor 1209.

In some embodiments, the deep learning network 1207 may be a deep learning network for implementing control commands for controlling the autonomous vehicle. For example, the deep learning network 1207 may be an artificial neural network such as a convolution neural network (CNN) trained using sensor data, and the output of the deep learning network 1207 is provided to the vehicle control module 1211.

In some embodiments, the AI processor 1209 may be a hardware processor for running the deep learning network 1207. In some embodiments, the AI processor 1209 may be a specialized AI processor adapted to perform inference on sensor data through a CNN. In some embodiments, the AI processor 1209 may be optimized for a bit depth of the sensor data. In some embodiments, the AI processor 1209 may be optimized for deep learning operations such as operations in neural networks including convolution, inner product, vector, and/or matrix operations. In some embodiments, the AI processor 1209 may be implemented through a plurality of graphics processing units (GPUs) capable of effectively performing parallel processing.

In various embodiments, the AI processor 1209 may be coupled, through an input/output interface, to a memory configured to provide an AI processor having instructions causing the AI processor to perform deep learning analysis on the sensor data received from the sensor(s) 1203 while the AI processor 1209 is executed, and determine a result of machine learning used to operate a vehicle at least partially autonomously. In some embodiments, the vehicle control module 1211 may be used to process commands for vehicle control outputted from the AI processor 1209, and to translate the output of the AI processor 1209 into commands for controlling modules of each vehicle in order to control various modules in the vehicle. In some embodiments, the vehicle control module 1211 is used to control an autonomous driving vehicle. In some embodiments, the vehicle control module 1211 may adjust the steering and/or speed of the vehicle. For example, the vehicle control module 1211 may be used to control driving of a vehicle such as e.g., deceleration, acceleration, steering, lane change, keeping lane or the like. In some embodiments, the vehicle control module 1211 may generate control signals for controlling vehicle lighting, such as e.g., brake lights, turns signals, and headlights. In some embodiments, the vehicle control module 1211 may be used to control vehicle audio-related systems such as e.g., a vehicle's sound system, vehicle's audio warnings, a vehicle's microphone system, and a vehicle's horn system.

In some embodiments, the vehicle control module 1211 may be used to control notification systems including alert systems for notifying passengers and/or a driver of driving events, such as e.g., approaching an intended destination or a potential collision. In some embodiments, the vehicle control module 1211 may be used to adjust sensors such as the sensors 1203 of the vehicle. For example, the vehicle control module 1211 may control to modify the orientation of the sensors 1203, change the output resolution and/or format type of the sensors 1203, increase or decrease a capture rate, adjust a dynamic range, and adjust the focus of the camera. In addition, the vehicle control module 1211 may control to turn on/off the operation of the sensors individually or collectively.

In some embodiments, the vehicle control module 1211 may be used to change the parameters of the image preprocessor 1205 by means of modifying a frequency range of filters, adjusting features and/or edge detection parameters for object detection, adjusting bit depth and channels, or the like. In various embodiments, the vehicle control module 1211 may be used to control autonomous driving of the vehicle and/or driver assistance features of the vehicle.

In some embodiments, the network interface 1213 may serve as an internal interface between the block components of the autonomous driving control system 1200 and the communication unit 1215. Specifically, the network interface 1213 may be a communication interface for receiving and/or transmitting data including voice data. In various embodiments, the network interface 1213 may be connected to external servers via the communication unit 1215 to connect voice calls, receive and/or send text messages, transmit sensor data, update software of the vehicle to the autonomous driving system, or update software of the autonomous driving system of the vehicle.

In various embodiments, the communication unit 1215 may include various wireless interfaces of a cellular or WiFi type. For example, the network interface 1213 may be used to receive updates of the operation parameters and/or instructions for the sensors 1203, the image preprocessor 1205, the deep learning network 1207, the AI processor 1209, and the vehicle control module 1211 from an external server connected via the communication unit 1215. For example, a machine learning model of the deep learning network 1207 may be updated using the communication unit 1215. According to another embodiment, the communication unit 1215 may be used to update the operating parameters of the image preprocessor 1205, such as image processing parameters, and/or the firmware of the sensors 1203.

In another embodiment, the communication unit 1215 may be used to activate communication for emergency services and emergency contacts in an event of a traffic accident or a near-accident. For example, in a vehicle crash event, the communication unit 1215 may be used to call emergency services for help, and may be used to externally notify the crash details and the location of the vehicle to the designated emergency services. In various embodiments, the communication unit 1215 may update or obtain an expected arrival time and/or a location of destination.

According to an embodiment, the autonomous driving system 1200 illustrated in FIG. 12 may be configured as an electronic device of a vehicle. According to an embodiment, when an autonomous driving release event occurs from the user while performing the autonomous driving of the vehicle, the AI processor 1209 of the autonomous driving system 1200 may make a control to input information related to the autonomous driving release event to the training set data of the deep learning network, thereby controlling to train the autonomous driving software of the vehicle.

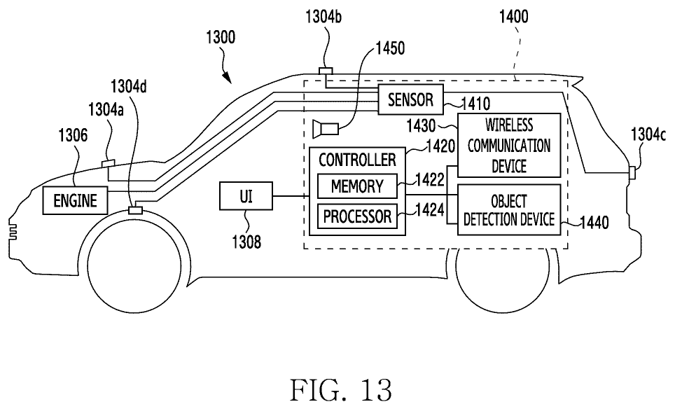

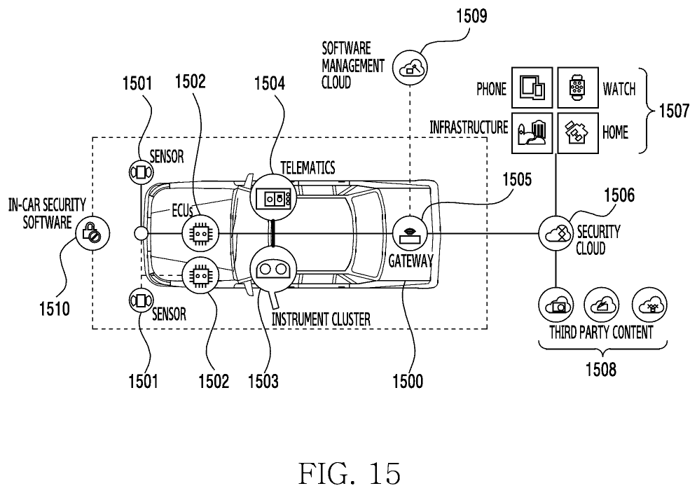

FIGS. 13 and 14 are example block diagrams illustrating an autonomous driving mobile body according to an embodiment. FIG. 15 illustrates an example of a gateway related to a user device according to various embodiments.

Referring to FIG. 13, the autonomous driving mobile body 1300 according to the present embodiment may include a control device 1400, sensing modules (1304a, 1304b, 1304c, 1304d), an engine 1306, and a user interface 1308.

The autonomous driving mobile body 1300 may have an autonomous driving mode or a manual mode. For example, according to a user input received through the user interface 1308, the manual mode may be switched to the autonomous driving mode, or the autonomous driving mode may be switched to the manual mode.

When the mobile body 1300 is operated in the autonomous driving mode, the autonomous driving mobile body 1300 may be operated under the control of the control device 1400.

In this embodiment, the control device 1400 may include a controller 1420 including a memory 1422 and a processor 1424, a sensor 1410, a communication device 1430, and an object detection device 1440.

Here, the object detection device 1440 may perform all or some of functions of the distance measuring device (e.g., the electronic device 101).

In other words, in the present embodiment, the object detection device 1440 is a device for detecting an object located outside the mobile body 1300, and the object detection device 1440 may be configured to detect an object located outside the mobile body 1300 and generate object information according to a result of the detection.

The object information may include information on the presence or absence of an object, location information of the object, distance information between the mobile body and the object, and relative speed information between the mobile body and the object.

The object may include various objects located outside the mobile body 1300, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1440 may include a camera module. The controller 1420 may extract object information from an external image captured by the camera module and allow the controller 1420 to process the information.

Further, the object detection device 1440 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1300 and the object, and control the operation of the mobile body based on the distance calculated in association with the control device 1400 of the autonomous driving mobile body 1300.

For example, when there is a possibility of collision depending upon the distance between the autonomous driving mobile body 1300 and the object, the autonomous driving mobile body 1300 may control the brake to slow down or stop. As another example, when the object is a moving object, the autonomous driving mobile body 1300 may control the driving speed of the autonomous driving mobile body 1300 to maintain a predetermined distance or more from the object.

The distance measuring device according to an embodiment of the disclosure may be configured as one module within the control device 1400 of the autonomous driving mobile body 1300. In other words, the memory 1422 and the processor 1424 of the control device 1400 may be configured to implement in software a collision avoidance method according to the present disclosure.

Further, the sensor 1410 may be connected to the sensing modules (1304a, 1304b, 1304c, 1304d) to obtain various sensing information about the environment inside and outside the mobile body. Here, the sensor 1410 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1410 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1410 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1410 may generate mobile body state information based on various detected data.

A wireless communication device 1430 may be configured to implement wireless communication between the autonomous driving mobile bodies 1300. For example, the autonomous driving mobile body 1300 can communicate with a mobile phone of the user or another wireless communication device 1430, another mobile body, a central apparatus (traffic control device), a server, or the like. The wireless communication device 1430 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1300 may implement wireless communication between mobile bodies via the wireless communication device 1430. In other words, the wireless communication device 1430 may communicate with another mobile body and other mobile bodies over the road through vehicle-to-vehicle (V2V) communication. The autonomous driving mobile body 1300 may transmit and receive information, such as driving warnings and traffic information, via the vehicle-to-vehicle communication, and may request information or receive such a request from another vehicle. For example, the wireless communication device 1430 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1430.

Further, the wireless communication device 1430 may obtain, as information for autonomous driving of the autonomous driving mobile body 1300, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1430 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1300.

For example, the wireless communication device 1430 may perform wireless communication with various platforms that configure a Non-Terrestrial Network (NTN) according to the wireless access specification complying with the 5G NR NTN (5th Generation New Radio Non-Terrestrial Network) standard currently being discussed in 3GPP and others, but the disclosure is not limited thereto.

In this embodiment, the controller 1420 may control the wireless communication device 1430 to select a platform capable of appropriately performing the NTN communication in consideration of various information, such as the location of the autonomous driving mobile body 1300, the current time, available power, and the like and to perform wireless communication with the selected platform.

In this embodiment, the controller 1420, which is a unit for controlling the overall operation of each unit in the mobile body 1300, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1420 configured at the time of its manufacturing. Such a controller 1420 may be referred to as an electronic control unit (ECU).

The controller 1420 may be configured to collect various data from the sensor 1410 connected thereto, the object detection device 1440, the communication device 1430, and the like, and may transmit a control signal based on the collected data to the sensor 1410, the engine 1306, the user interface 1308, the wireless communication device 1430, and the object detection device 1440 that are included as other components in the mobile body. Further, although not shown herein, the control signal may be also transmitted to an accelerator, a braking system, a steering device, or a navigation device related to driving of the mobile body.

According to the present embodiment, the controller 1420 may control the engine 1306, and for example, the controller 1420 may control the engine 1306 to detect a speed limit of the roadway on which the autonomous driving mobile body 1300 is driving and to prevent its driving speed from exceeding the speed limit, or may control the engine 1306 to accelerate the driving speed of the autonomous driving mobile body 1300 within a range not exceeding the speed limit.

Further, in case where the autonomous driving mobile body 1300 is approaching the lane or departing from the lane during the driving of the autonomous driving mobile body 1300, the controller 1420 may determine whether such approaching the lane or departing from the lane is due to a normal driving condition or other driving conditions, and control the engine 1306 to control the driving of the vehicle based on the result of determination. More specifically, the autonomous driving mobile body 1300 may detect lanes formed on both sides of the lane in which the vehicle is driving. In such a case, the controller 1420 may determine whether the autonomous driving mobile body 1300 is approaching the lane or departing from the lane, and if it is determined that the autonomous driving mobile body 1300 is approaching the lane or departing from the lane, then the controller 1420 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1300 is approaching or leaving the lane in a situation where it is not necessary for the mobile body to change the lane, the controller 1420 may control the driving of the autonomous driving mobile body 1300 such that the autonomous driving mobile body 1300 does not leave the lane and continue to drive normally in that lane.

When another mobile body or any obstruction exists in front of the mobile body, the controller may control the engine 1306 or the braking system to decelerate the mobile body, and control the trajectory, the driving route, and the steering angle of the mobile body in addition to the driving speed. Alternatively, the controller 1420 may control the driving of the mobile body by generating necessary control signals based on information collected from the external environment, such as, e.g., the driving lane of the mobile body, the driving signals, and the like.

In addition to generating its own control signals, the controller 1420 may communicate with a neighboring mobile body or a central server and transmit commands for controlling peripheral devices through the information received therefrom, thereby controlling the driving of the mobile body.

Further, when the position of the camera module 1450 changes or the angle of view changes, it may be difficult to accurately recognize the mobile body or the lane in accordance with the present embodiment, and thus the controller 1420 may generate a control signal for controlling to perform calibration of the camera module 1450 in order to prevent such a phenomenon. Accordingly, in this embodiment, the controller 1420 may generate a calibration control signal to the camera module 1450 to continuously maintain the normal mounting position, orientation, angle of view, etc. of the camera module 1450, even if the mounting position of the camera module 1450 is changed due to vibrations or impacts generated according to the movement of the autonomous driving mobile body 1300. The controller 1420 may generate a control signal to perform calibration of the camera module 1450, in case where the pre-stored initial information of mounting position, orientation, and angle of view of the camera module 1450 varies by more than a threshold value from the initial mounting position, direction, and angle of view information of the camera module 1450 measured during the driving of the autonomous driving mobile body 1300.

In this embodiment, the controller 1420 may include a memory 1422 and a processor 1424. The processor 1424 may execute software stored in the memory 1422 according to a control signal of the controller 1420. More specifically, the controller 1420 may store in the memory 1422 data and instructions for performing the lane detection method in accordance with the present disclosure, and the instructions may be executed by the processor 1424 to implement the one or more methods disclosed herein.

In such a circumstance, the memory 1422 may be included in a non-volatile recording medium executable by the processor 1424. The memory 1422 may store software and data through an appropriate internal and external device. The memory 1422 may be comprised of a random access memory (RAM), a read only memory (ROM), a hard disk, and another memory 1422 connected to a dongle.

The memory 1422 may store at least an operating system (OS), a user application, and executable instructions. The memory 1422 may also store application data, array data structures and the like.

The processor 1424 may be a microprocessor or an appropriate electronic processor, such as a controller, a microcontroller, or a state machine.

The processor 1424 may be implemented as a combination of computing devices, and the computing device may include a digital signal processor, a microprocessor, or an appropriate combination thereof.

Meanwhile, the autonomous driving mobile body 1300 may further include a user interface 1308 for a user input to the control device 1400 described above. The user interface 1308 may allow the user to input information with appropriate interaction. For example, it may be implemented as a touch screen, a keypad, a control button, etc. The user interface 1308 may transmit an input or command to the controller 1420, and the controller 1420 may perform a control operation of the mobile body in response to the input or command.

Further, the user interface 1308 may allow a device outside the autonomous driving mobile body 1300 to communicate with the autonomous driving mobile body 1300 through the wireless communication device 1430. For example, the user interface 1308 may be in association with a mobile phone, a tablet, or other computing devices.

Furthermore, this embodiment describes that the autonomous driving mobile body 1300 includes the engine 1306, but it may be also possible to include another type of propulsion system. For example, the mobile body may be operated with electrical energy or may be operable by means of hydrogen energy or a hybrid system in combination thereof. Thus, the controller 1420 may include a propulsion mechanism according to the propulsion system of the autonomous driving mobile body 1300, and may provide control signals to components of each of the propulsion mechanism accordingly.

Hereinafter, a detailed configuration of the control device 1400 according to the present embodiment will be described in more detail with reference to FIG. 14.

The control device 1400 includes a processor 1424. The processor 1424 may be a general-purpose single-chip or multi-chip microprocessor, a dedicated microprocessor, a microcontroller, a programmable gate array, or the like. The processor may be referred to as a central processing unit (CPU). In this embodiment, the processor 1424 may be implemented with a combination of a plurality of processors.

The control device 1400 also includes a memory 1422. The memory 1422 may be any electronic component capable of storing electronic information. The memory 1422 may also include a combination of memories 1422 in addition to a single memory.

Data and instructions 1422a for performing a distance measuring method of the distance measuring device according to the present disclosure may be stored in the memory 1422. When the processor 1424 executes the instructions 1422a, all or some of the instructions 1422a and the data 1422b required for executing the instructions may be loaded onto the processor 1424 (e.g., 1424a or 1424b).

The control device 1400 may include a transmitter 1430a, a receiver 1430b, or a transceiver 1430c for allowing transmission and reception of signals. The one or more antennas (1432a, 1432b) may be electrically connected to the transmitter 1430a, the receiver 1430b, or each transceiver 1430c, or may further include antennas.

The control device 1400 may include a digital signal processor (DSP) 1470. The DSP 1470 may allow the mobile body to quickly process digital signals.

The control device 1400 may include a communication interface 1480. The communication interface 1480 may include one or more ports and/or communication modules for connecting other devices to the control device 1400. The communication interface 1480 may allow the user and the control device 1400 to interact with each other.

Various components of the control device 1400 may be connected together by one or more buses 1490, and the buses 1490 may include a power bus, a control signal bus, a state signal bus, a data bus, and the like. Under the control of the processor 1424, the components may transmit information to each other via the bus 1490 and perform a desired function.

Meanwhile, in various embodiments, the control device 1400 may be related to a gateway for communication with a security cloud. Referring to FIG. 15, the control device 1400 may be related to a gateway 1505 for providing information obtained from at least one of components 1501 to 1504 of a vehicle 1500 to a security cloud 1506. For example, the gateway 1505 may be included in the control device 1400. As another example, the gateway 1505 may be configured as a separate device in the vehicle 1500 distinguished from the control device 1400. The gateway 1505 connects a software management cloud 1509 and a security cloud 1506, having different networks, with the network within the vehicle 1500 secured by in-car security software 1510, so that they can communicate with each other.

For example, a component 1501 may be a sensor. For example, the sensor may be used to obtain information about at least one of a state of the vehicle 1500 or a state around the vehicle 1500. For example, the component 1501 may include a sensor 1410.

For example, a component 1502 may be an electronic control unit (ECU). For example, the ECU may be used for engine control, transmission control, airbag control, and tire air-pressure management.

For example, a component 1503 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1500, visual elements for indicating a remaining fuel amount, visual elements for indicating a state of a transmission gear, or visual elements for indicating information obtained through the element 1501.

For example, a component 1504 may be a telematics device. For example, the telematics device may refer to an apparatus that combines wireless communication technology and global positioning system (GPS) technology to provide various mobile communication services, such as location information, safe driving or the like in the vehicle 1500. For example, the telematics device may be used to connect the vehicle 1500 with the driver, a cloud (e.g., the security cloud 1506), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1500.

For example, the gateway 1505 may be used to connect the in-vehicle network within the vehicle 1500 with the software management cloud 1509 and the security cloud 1506, which are out-of-vehicle networks. For example, the software management cloud 1509 may be used to update or manage at least one software required for driving and managing of the vehicle 1500. For example, the software management cloud 1509 may be associated with the in-car security software 1510 installed in the vehicle. For example, the in-car security software 1510 may be used to provide a security function in the vehicle 1500. For example, the in-car security software 1510 may encrypt data transmitted and received via the in-vehicle network, using an encryption key obtained from an external authorized server for encryption of the in-vehicle network. In various embodiments, the encryption key used by the in-car security software 1510 may be generated based on the vehicle identification information (vehicle license plate, vehicle identification number (VIN)) or information uniquely assigned to each user (e.g., user identification information).

In various embodiments, the gateway 1505 may transmit data encrypted by the in-car security software 1510 based on the encryption key, to the software management cloud 1509 and/or the security cloud 1506. The software management cloud 1509 and/or the security cloud 1506 may use a decryption key capable of decrypting the data encrypted by the encryption key of the in-car security software 1510 to identify from which vehicle or user the data has been received. For example, since the decryption key is a unique key corresponding to the encryption key, the software management cloud 1509 and/or the security cloud 1506 may identify a sending entity (e.g., the vehicle or the user) of the data based on the data decrypted using the decryption key.

For example, the gateway 1505 may be configured to support the in-car security software 1510 and may be related to the control device 1400. For example, the gateway 1505 may be related to the control device 1400 to support a connection between the client device 1507 connected to the security cloud 1506 and the control device 1400. As another example, the gateway 1505 may be related to the control device 1400 to support a connection between a third party cloud 1508 connected to the security cloud 1506 and the control device 1400. However, the disclosure is not limited thereto.

In various embodiments, the gateway 1505 may be used to connect the vehicle 1500 to the software management cloud 1509 for managing the operating software of the vehicle 1500. For example, the software management cloud 1509 may monitor whether update of the operating software of the vehicle 1500 is required, and may provide data for updating the operating software of the vehicle 1500 through the gateway 1505, based on monitoring that the update of the operating software of the vehicle 1500 is required. As another example, the software management cloud 1509 may receive a user request to update the operating software of the vehicle 1500 from the vehicle 1500 via the gateway 1505 and provide data for updating the operating software of the vehicle 1500 based on the received user request. However, the disclosure is not limited thereto.

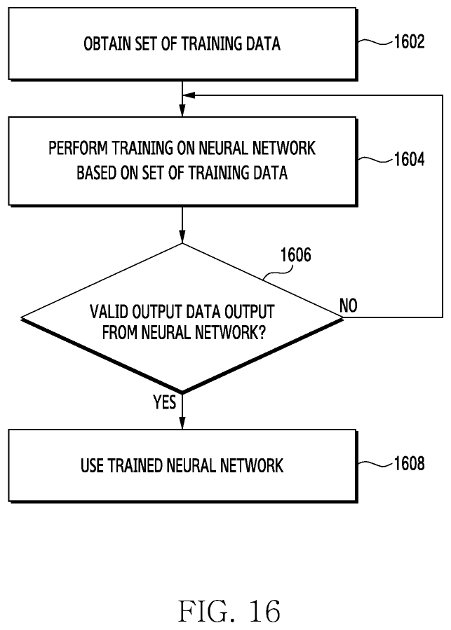

FIG. 16 is a view illustrating operations of an electronic device training a neural network based on a set of training data according to an embodiment.

The operations described with reference to FIG. 16 may be performed by the above-described electronic device (e.g., the electronic device 100 of FIG. 2).

Referring to FIG. 16, in operation 1602, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1602 may include pairs of a plurality of training data. In the example of training the neural network for image recognition, the set of training data identified by the electronic device may include a plurality of images and ground truth data corresponding to each of the plurality of images.

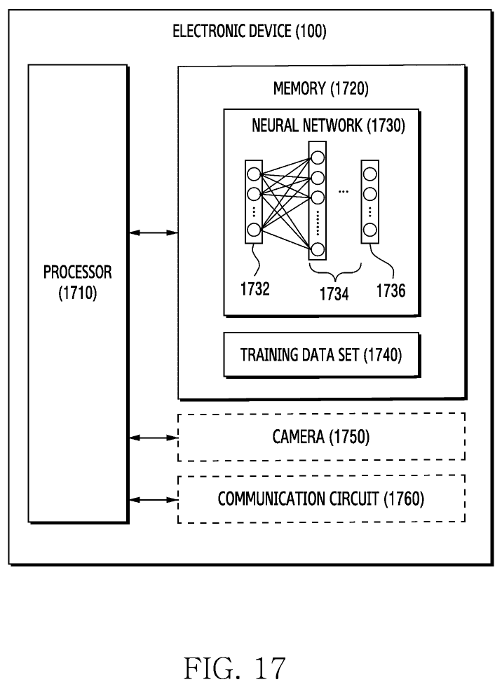

Referring to FIG. 16, in operation 1604, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 17. From the output layer of the neural network receiving the input data through the input layer, the electronic device may obtain output data of the neural network corresponding to the input data.

In an embodiment, the training of operation 1604 may be performed based on a difference between the output data and the ground truth data included in the training data and corresponding to the input data. For example, the electronic device may adjust one or more parameters (e.g., weights described below with reference to FIG. 17) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 16, in operation 1606, according to an embodiment, the electronic device may identify whether valid output data is output from the neural network trained in operation 1604. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1606), the electronic device may repeatedly perform training of the neural network based on operation 1604. The embodiments are not limited thereto, and the electronic device may repeatedly perform operations 1602 and 1604.

In a state in which valid output data is obtained from the neural network (Yes in 1606), based on operation 1608, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 17 is a block diagram illustrating an electronic device according to an embodiment.

The electronic device 100 of FIG. 17 may include the above-described electronic device.

For example, the operations described with reference to FIG. 16 may be performed by the electronic device 100 of FIG. 17 and/or the processor 1710 of FIG. 17.

Referring to FIG. 17, a processor 1710 of the electronic device 100 may perform computations related to a neural network 1730 stored in a memory 1720. The processor 1710 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 17, the processor 1710 may identify the neural network 1730 stored in the memory 1720. The neural network 1730 may include a combination of an input layer 1732, one or more hidden layers 1734 (or intermediate layers), and an output layer 1736. The above-described layers (e.g., the input layer 1732, the one or more hidden layers 1734, and the output layer 1736) may include a plurality of nodes. The number of hidden layers 1734 may vary depending on embodiments, and the neural network 1730 including a plurality of hidden layers 1734 may be referred to as a deep neural network. Operation of training the deep neural network may be referred to as deep learning.

In an embodiment, when the neural network 1730 has a structure of a feed forward neural network, a first node included in a particular layer may be connected to all of second nodes included in another prior to that particular layer. In the memory 1720, the parameters stored for the neural network 1730 may include weights assigned to connections between the second nodes and the first node. In the neural network 1730 having such a structure of feedforward neural network, a value of the first node may correspond to a weighted sum of values assigned to the second nodes, based on weights assigned to connections connecting the second nodes and the first node.

In an embodiment, when the neural network 1730 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1720, the parameters stored for the neural network 1730 may include weights indicating the filter. The filter may include, among the second nodes, one or more nodes to be used to calculate a weighted sum of the first nodes, and weights corresponding to the one or more nodes, respectively.

According to an embodiment, the processor 1710 of the electronic device 100 may perform training on the neural network 1730, using the training data set 1740 stored in the memory 1720. Based on the training data set 1740, the processor 1710 may adjust one or more parameters stored in the memory 1720 for the neural network 1730.

According to an embodiment, the processor 1710 of the electronic device 100 may perform object detection, object recognition, and/or object classification, using the neural network 1730 trained based on the training data set 1740. The processor 1710 may input an image (or video) obtained through the camera 1750 to the input layer 1732 of the neural network 1730. Based on the input layer 1732 to which the image is input, the processor 1710 may sequentially obtain values of nodes of layers included in the neural network 1730 to obtain a set (e.g., output data) of values of nodes of the output layer 1736. The output data may be used based on a result of inferring information included in the image using the neural network 1730. Embodiments of the disclosure are not limited thereto, and the processor 1710 may input, to the neural network 1730, an image (or video) obtained from an external electronic device connected to the electronic device 100 through the communication circuit 1760.

In an embodiment, the neural network 1730 trained to process an image may be used to identify an area corresponding to a subject in the image (e.g., object detection) and/or identify a class of the subject represented in the image (e.g., object recognition and/or object classification). For example, the electronic device 100 may segment an area corresponding to the subject in the image, based on a rectangular shape such as e.g., a bounding box, using the neural network 1730. For example, the electronic device 100 may identify at least one class that matches the subject from among a plurality of specified classes, using the neural network 1730.

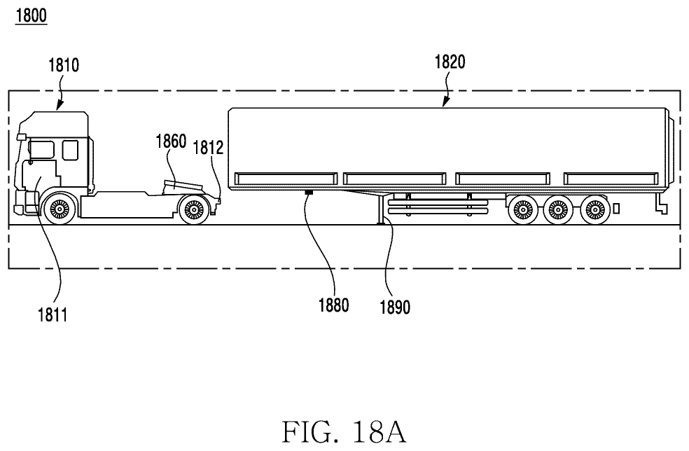

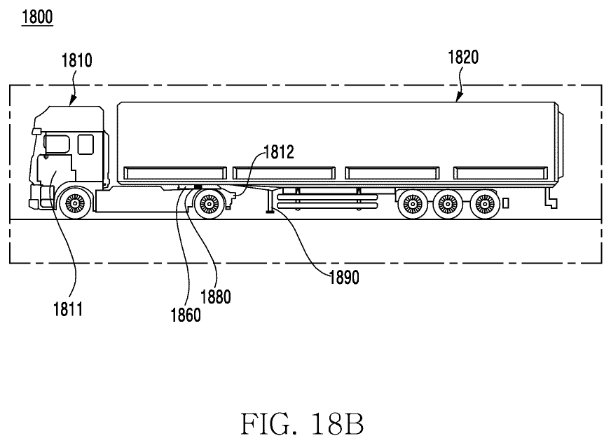

FIGS. 18A and 18B illustrate an example of a vehicle.

The above-described platooning vehicle may be referred to as a conventional truck.

Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

The trailer shown in FIGS. 18A and 18B of the disclosure is illustrated as a “semi-trailer”, but this is for convenience of description, and it should not be understood that the embodiments of the disclosure are applied only to a “semi-trailer” form.

Referring to FIGS. 18A and 18B, a vehicle 1800 including a tractor or tractor unit 1810 and a semi-trailer 1820 is exemplarily illustrated. FIG. 18A illustrates a state in which the tractor 1810 and the semi-trailer 1820 are not connected, and FIG. 18B illustrates a state in which the tractor 1810 and the semi-trailer 1820 are connected. In an embodiment, the semi-trailer 1820 may be selectively connected by a fifth wheel hitch 1860 carried by the tractor 1810, and the fifth wheel hitch 1860 may engage to the kingpin 1880 fixed to the semi-trailer 1820 in a known manner. The vehicle 1800 including the tractor 1810 and the semi-trailer 1820 may be referred to as a truck. The vehicle 1800 may include only the tractor 1810. The semi-trailer 1820 shown in FIGS. 18A and 18B is illustrated as a “semi-trailer” form, but this is for convenience of description, and it should not be understood that the embodiments of the disclosure are applied only to a “semi-trailer” form. The tractor 1810 shown in FIGS. 18A and 18B is illustrated as a “cab-over truck” form, but this is for convenience of description, and it should not be understood that the embodiments of the disclosure are applied only to a “cab-over truck” form.

In an embodiment, the tractor 1810 may include a front part 1811 and a rear part 1812. The front part 1811 may include a cab or cabin in which the driver sits. The rear part 1812 may be equipped with a fifth wheel hitch 1860 to which the semi-trailer 1820 is coupled. In an embodiment, the semi-trailer 1820 may include a king pin 1880 coupled to the fifth wheel hitch 1860 of the tractor 1810 and a landing gear 1890 that supports the semi-trailer 1820 against the ground when the semi-trailer 1820 is not coupled to the tractor 1810. The king pin 1880 and the landing gear 1890 may be installed on the lower portion of the semi-trailer 1820.

In an embodiment, the tractor 1810 may include an internal combustion engine, referred to as an engine, a motor, or a combination thereof. The tractor 1810 may include a battery and/or a fuel tank (e.g., a fuel tank designed to store gasoline, diesel, liquid natural gas (LNG), liquefied petroleum gas (LPG) and/or hydrogen). For example, the tractor 1810 including a rechargeable battery and a motor driven by electrical energy stored in the battery may be referred to as an electric vehicle (EV) and/or an electric truck. For example, the tractor 1810 including not only a battery and a motor but also a fuel tank and an engine may be referred to as a hybrid vehicle (e.g., plug-in hybrid electric vehicle (PHEV)).

In an embodiment, the semi-trailer 1820 may be coupled to or detached from the tractor 1810. For example, the semi-trailer 1820 may be connected to the rear part 1812 of the tractor 1810. The semi-trailer 1820 coupled to the tractor 1810 may be towed by the tractor 1810. To support driving on curved roads, the semi-trailer 1820 may be rotatably coupled to the tractor 1810. For example, the tractor 1810 and the semi-trailer 1820 may be rotatably coupled through a coupling device including the fifth wheel hitch 1860 and the king pin 1880. However, the link mechanism between the tractor 1810 and the semi-trailer 1820 is not limited thereto.

An electronic for platooning of vehicles is provided. An electronic device according to an embodiment may comprise a processor and a memory storing instructions. The instructions may, when executed by the processor, cause the electronic device to identify first information related to a first formation of the vehicles, obtain second information related to whether at least a portion of a second lane, which is distinct from the first lane where the vehicles are located, is unoccupied while controlling the vehicles in the first formation, determine a second formation to move some of the vehicles to the second lane, based on the second information, distinguish the vehicles into a first group of vehicles including a leading vehicle and a second group of vehicles including only following vehicles, based on the second formation, and transmit a signal to the following vehicles included in the second group of vehicles to move the second group of vehicles to the second lane.

The electronic device according to an embodiment may further comprise a camera. The second information may include first environmental information related to a surrounding environment of the leading vehicle obtained via the camera, and second environmental information related to a surrounding environment of the following vehicles received from the following vehicles.

According to an embodiment, the instructions may, when executed by the processor, cause the electronic device to determine the second formation, based on identifying that the second lane includes a plurality of lanes at least partially unoccupied, the second formation including a first row corresponding to the first lane and a plurality of second rows corresponding to the plurality of lanes, respectively, and distinguish the vehicles into the first group of vehicles and a plurality of third group of vehicles corresponding to the second rows, respectively, based on the second formation, and transmit a signal to following vehicles included in the plurality of third group of vehicles, the signal to move the plurality of third group of vehicles to the plurality of lanes.

According to an embodiment, the plurality of lanes may include a third lane and a fourth lane. The plurality of second rows may include a third row corresponding to the third lane and a fourth row corresponding to the fourth lane. The plurality of third group of vehicles may include a fourth group of vehicles including a first following vehicle moving from the first lane to the third lane, and a fifth group of vehicles including a second following vehicle moving from the first lane to the fourth lane.

According to an embodiment, the instructions may, when executed by the processor, cause the electronic device to transmit a first signal to the first following vehicle, the first signal for moving the first following vehicle from the first lane to the lane, control the second following vehicle included in the fifth group of vehicles so that the second following vehicle is positioned on the first lane, while the first following vehicle moves from the first lane to the third lane, and transmit a second signal to the second following vehicle, based on a completion of movement of the first following vehicle to the third lane, the second signal for moving the second following vehicle from the first lane to the fourth lane.

According to an embodiment, the instructions may, when executed by the processor, cause the electronic device to receive, from the first following vehicle, third information related to whether at least a portion of the fourth lane is unoccupied, while the first following vehicle moves from the first lane to the third lane, and transmit the second signal to the second following vehicle, based on the third information.

According to an embodiment, the instructions may, when executed by the processor, cause the electronic device to transmit the second signal to the second following vehicle, in response to identifying at least a portion of the fourth lane unoccupied based on the third information, and stop transmitting the second signal, in response to identifying at least a portion of the fourth lane occupied by another vehicle based on the third information.

According to an embodiment, the instructions may, when executed by the processor, cause the electronic device to transmit a signal to move the second group of vehicles to the second lane, to change the first formation to the second formation, while the vehicles wait for a stop light.

According to an embodiment, the instructions may, when executed by the processor, cause the electronic device to obtain first time information related to a remaining time of the stop light, calculate second time information related to a time required to change the first formation to the second formation, and transmit the signal to move the second group of vehicles to the second lane, based on the second time information shorter than the first time information.

According to an embodiment, the instructions may, when executed by the processor, cause the electronic device to identify a first region of the second lane at least partially unoccupied and a second region of the second lane occupied by another vehicle on the second lane, based on the second information, and determine the second formation to move the second group of vehicles to the first region of the second lane, based on the first region and the second region.

According to an embodiment, the number of rows of the second formation may be greater than the number of rows of the first formation.

According to an embodiment, the instructions may, when executed by the processor, cause the electronic device to generate a local map indicating information related to a surrounding environment of the vehicles, based on the second information.

According to an embodiment, the instructions may, when executed by the processor, cause the electronic device to obtain the second information and determine the second formation, using a neural network model.

A method performed by an electronic device is provided. A method of an electronic device according to an embodiment may comprise identifying first information related to a first formation of platooning vehicles. The method may comprise obtaining second information related to whether at least a portion of a second lane, which is distinct from the first lane where the vehicles are located, is unoccupied while controlling the vehicles in the first formation. The method may comprise determining a second formation to move some of the vehicles to the second lane, based on the second information. The method may comprise distinguishing the vehicles into a first group of vehicles including a leading vehicle and a second group of vehicles including only following vehicles, based on the second formation. The method may comprise transmitting a signal to the following vehicles included in the second group of vehicles to move the second group of vehicles to the second lane.

The method according to an embodiment may further comprise determining the second formation, based on identifying that the second lane includes a plurality of lanes at least partially unoccupied, the second formation including a first row corresponding to the first lane and a plurality of second rows corresponding to the plurality of lanes, respectively. The method may further comprise distinguishing the vehicles into the first group of vehicles and a plurality of third group of vehicles corresponding to the second rows, respectively, based on the second formation. The method may further comprise transmitting a signal to following vehicles included in the plurality of third group of vehicles, the signal to move the plurality of third group of vehicles to the plurality of lanes.

The method according to an embodiment may further comprise transmitting a signal to move the second group of vehicles to the second lane, to change the first formation to the second formation, while the vehicles wait for a stop light.

The method according to an embodiment may further comprise obtaining first time information related to a remaining time of the stop light. The method may further comprise calculating second time information related to a time required to change the first formation to the second formation. The method may further comprise transmitting the signal to move the second group of vehicles to the second lane, based on the second time information shorter than the first time information.

The method according to an embodiment may further comprise identifying a first region of the second lane at least partially unoccupied and a second region of the second lane occupied by another vehicle on the second lane, based on the second information. The method may further comprise determining the second formation to move the second group of vehicles to the first region of the second lane, based on the first region and the second region.

The method according to an embodiment may further comprise generating a local map indicating information related to a surrounding environment of the vehicles, based on the second information.

The method according to an embodiment may further comprise obtaining the second information and determining the second formation, using a neural network model.

What is claimed is:

1. An electronic for platooning of vehicles, the electronic device comprising:
a processor; and
a memory storing instructions,
wherein the instructions, when executed by the processor, cause the electronic device to:
identify first information related to a first formation of the vehicles where the vehicles are located on a first lane;
obtain second information related to whether at least a portion of a second lane, which is distinct from the first lane, is unoccupied while controlling the vehicles in the first formation;
determine a second formation to move some of the vehicles to the second lane, based on the second information;
distinguish the vehicles into a first group of vehicles including a leading vehicle and a second group of vehicles including only following vehicles, based on the second formation; and
transmit a signal to the following vehicles included in the second group of vehicles to move the second group of vehicles to the second lane.

2. The electronic device of claim 1, further comprising a camera,
wherein the second information includes:
first environmental information related to a surrounding environment of the leading vehicle obtained via the camera; and
second environmental information related to a surrounding environment of the following vehicles received from the following vehicles.

3. The electronic device of claim 1,
wherein the instructions, when executed by the processor, cause the electronic device to:
determine the second formation, based on identifying that the second lane includes a plurality of lanes at least partially unoccupied, the second formation including a first row corresponding to the first lane and a plurality of second rows corresponding to the plurality of lanes, respectively; and
distinguish the vehicles into the first group of vehicles and a plurality of third group of vehicles corresponding to the second rows, respectively, based on the second formation; and
transmit a signal to following vehicles included in the plurality of third group of vehicles, the signal to move the plurality of third group of vehicles to the plurality of lanes.

4. The electronic device of claim 3,
wherein the plurality of lanes include a third lane and a fourth lane,
wherein the plurality of second rows include:
a third row corresponding to the third lane, and
a fourth row corresponding to the fourth lane, and wherein the plurality of third group of vehicles include:
a fourth group of vehicles including a first following vehicle moving from the first lane to the third lane, and
a fifth group of vehicles including a second following vehicle moving from the first lane to the fourth lane.

5. The electronic device of claim 4,
wherein the instructions, when executed by the processor, cause the electronic device to:
transmit a first signal to the first following vehicle, the first signal for moving the first following vehicle from the first lane to the third lane;
control the second following vehicle included in the fifth group of vehicles so that the second following vehicle is positioned on the first lane, while the first following vehicle moves from the first lane to the third lane; and
transmit a second signal to the second following vehicle, based on a completion of movement of the first following vehicle to the third lane, the second signal for moving the second following vehicle from the first lane to the fourth lane.

6. The electronic device of claim 5,
wherein the instructions, when executed by the processor, cause the electronic device to:
receive, from the first following vehicle, third information related to whether at least a portion of the fourth lane is unoccupied, while the first following vehicle moves from the first lane to the third lane; and
transmit the second signal to the second following vehicle, based on the third information.

7. The electronic device of claim 6,
wherein the instructions, when executed by the processor, cause the electronic device to:
transmit the second signal to the second following vehicle, in response to identifying at least a portion of the fourth lane unoccupied based on the third information; and
stop transmitting the second signal, in response to identifying at least a portion of the fourth lane occupied by another vehicle based on the third information.

8. The electronic device of claim 1,
wherein the instructions, when executed by the processor, cause the electronic device to:
transmit a signal to move the second group of vehicles to the second lane, to change the first formation to the second formation, while the vehicles wait for a stop light.

9. The electronic device of claim 8,
wherein the instructions, when executed by the processor, cause the electronic device to:
obtain first time information related to a remaining time of the stop light;
calculate second time information related to a time required to change the first formation to the second formation; and
transmit the signal to move the second group of vehicles to the second lane, based on the second time information shorter than the first time information.

10. The electronic device of claim 1,
wherein the instructions, when executed by the processor, cause the electronic device to:
identify a first region of the second lane at least partially unoccupied and a second region of the second lane occupied by another vehicle on the second lane, based on the second information; and
determine the second formation to move the second group of vehicles to the first region of the second lane, based on the first region and the second region.

11. The electronic device of claim 1,
wherein the number of rows of the second formation is greater than the number of rows of the first formation.

12. The electronic device of claim 1,
wherein the instructions, when executed by the processor, cause the electronic device to:
generate a local map indicating information related to a surrounding environment of the vehicles, based on the second information.

13. The electronic device of claim 1,
wherein the instructions, when executed by the processor, cause the electronic device to:
obtain the second information and determine the second formation, using a neural network model.

14. A method of an electronic for platooning of vehicles, the method comprising:
identifying first information related to a first formation of the vehicles where the vehicles are located on a first lane;
obtaining second information related to whether at least a portion of a second lane, which is distinct from the first lane, is unoccupied while controlling the vehicles in the first formation;
determining a second formation to move some of the vehicles to the second lane, based on the second information;
distinguishing the vehicles into a first group of vehicles including a leading vehicle and a second group of vehicles including only following vehicles, based on the second formation; and
transmitting a signal to the following vehicles included in the second group of vehicles to move the second group of vehicles to the second lane.

15. The method of claim 14, further comprising:
determining the second formation, based on identifying that the second lane includes a plurality of lanes at least partially unoccupied, the second formation including a first row corresponding to the first lane and a plurality of second rows corresponding to the plurality of lanes, respectively;
distinguishing the vehicles into the first group of vehicles and a plurality of third group of vehicles corresponding to the second rows, respectively, based on the second formation; and
transmitting a signal to following vehicles included in the plurality of third group of vehicles, the signal to move the plurality of third group of vehicles to the plurality of lanes.

16. The method of claim 14, further comprising:
transmitting a signal to move the second group of vehicles to the second lane, to change the first formation to the second formation, while the vehicles wait for a stop light.

17. The method of claim 16, further comprising:
obtaining first time information related to a remaining time of the stop light;
calculating second time information related to a time required to change the first formation to the second formation; and
transmitting the signal to move the second group of vehicles to the second lane, based on the second time information shorter than the first time information.

18. The method of claim 14, further comprising:
identifying a first region of the second lane at least partially unoccupied and a second region of the second lane occupied by another vehicle on the second lane, based on the second information; and
determining the second formation to move the second group of vehicles to the first region of the second lane, based on the first region and the second region.

19. The method of claim 14, further comprising:
generating a local map indicating information related to a surrounding environment of the vehicles, based on the second information.

20. The method of claim 14, further comprising:
obtaining the second information and determining the second formation, using a neural network model.
